(19) United States
(12) Patent Application Publication
(10) Pub. No.: US 2026/0011126 A1
(43) Pub. Date: Jan. 8, 2026

(54) AUTOMATIC ON-DEVICE POSE LABELING FOR TRAINING DATASETS TO FINE-TUNE MACHINE LEARNING MODELS USED FOR POSE ESTIMATION

(71) Applicant: Hinge Health, Inc., San Francisco, CA (US)

(72) Inventors: Sohail Zangenehpour, Beaconsfield (CA); Louis Harbour, Montreal (CA); Bahareh Bafandeh Mayvan, Montreal (CA); Dalei Wang, Montreal (CA); Connor MacDonald, Montreal (CA); Yuying Li, Montreal (CA); Tunai Porto Marques, Victoria (CA); Colin Joseph Brown, Saskatoon (CA); Lalith Vadlamannati, Seattle, WA (US)

(21) Appl. No.: 19/331,038

(22) Filed: Sep. 17, 2025

Related U.S. Application Data
(63) Continuation of application No. PCT/US24/23885, filed on Apr. 10, 2024.
(60) Provisional application No. 63/495,727, filed on Apr. 12, 2023.

(51) Int. Cl. G06V 10/774; G06V 10/764; G06V 10/776; G06V 10/82; G06V 40/20

(52) U.S. Cl. CPC G06V 10/7747; G06V 10/776; G06V 10/764; G06V 10/82; G06V 40/23

(57) ABSTRACT

The systems and methods for improving pose estimation models are disclosed herein. Digital image data of an environment can be obtained and provided to a first machine learning model. A first confidence metric can be computed for the image. The first confidence metric can be compared with a threshold value and provided to a second machine learning model. A second confidence metric can be generated for training of machine learning models for pose estimation. A generic machine learning model can be updated using model parameters from trained local machine learning models.

### CROSS-REFERENCE TO RELATED APPLICATIONS

This application is a continuation of International Application No. PCT/US2024/023885, titled “Automatic On-Device Pose Labeling for Training Datasets to Fine-Tune Machine Learning Models Used for Pose Estimation” and filed Apr. 10, 2023, which claims priority to U.S. Provisional Application No. 63/495,727, titled “Automatic On-Device Pose Labeling for Training Datasets to Fine-Tune Machine Learning Models Used for Pose Estimation” and filed on Apr. 12, 2023, each of which is incorporated herein by reference in its entirety.

### TECHNICAL FIELD

Various embodiments concern computer programs designed to improve performance of estimating poses in various environments and associated systems and methods.

### BACKGROUND

Exercise therapy is an intervention technique that utilizes physical activity as the principal treatment method for addressing the symptoms of musculoskeletal (MSK) conditions, such as acute physical ailments and chronic physical ailments. Exercise therapy programs may involve a plan for performing physical activities during exercise therapy sessions that occur on a periodic basis. Generally, the purpose of an exercise therapy program is to either restore normal MSK function or reduce the pain caused by an acute or chronic physical ailment, which may have been caused by injury or disease. As such, the physical activities to be performed in each exercise therapy session may be selected in order to achieve a specific therapeutic goal. Examples of therapeutic goals include lessening pain, improving flexibility, rehabilitating injuries, managing diseases, and the like.

These exercise therapy programs normally depict how a user should perform one or more physical activities to achieve a specific therapeutic goal within a time period. However, these exercise pose monitoring platforms usually are unable to monitor whether the user is properly performing the physical activities. For example, if the user is not using the proper technique to perform a physical activity, she may not experience improvement in her acute or chronic pain, flexibility, or the like, causing the user to become discouraged from doing her exercise therapy sessions. Therefore, a better approach is needed for monitoring pose to ensure that users are able to achieve lasting improvement in terms of MSK function. The benefits of improved performance of poses are not limited to exercise therapy programs.

Other systems that facilitate training a user to perform physical activities may also be unable to monitor whether a user is properly performing a variety of physical activities, such as dance moves, sporting techniques, exercises, cooking techniques, and the like. For example, if a user is not using proper form for her forehands, she may not be as successful in tennis matches compared to if she were using proper form. In another example, a user may be penalized in a cooking competition for not cutting her vegetables in a specific manner, and a system could have informed her with the ability to monitor her cutting technique. Thus, these systems need a way to monitor physical activities for users to achieve improved form.

### BRIEF DESCRIPTION OF THE DRAWINGS

FIG. 1 illustrates an example of a network environment that includes a pose monitoring platform.

FIG. 2A illustrates an example of a computing device able to implement a program in which a user is requested to perform physical activities, such as exercises, during sessions by a pose monitoring platform.

FIG. 2B illustrates an analysis module of the pose monitoring platform of FIG. 2A.

FIG. 3A depicts an example of a communication environment that includes a pose monitoring platform configured to receive several types of data.

FIG. 3B depicts another example of a communication environment that includes a pose monitoring platform configured to obtain data from one or more sources.

FIG. 4A depicts a flow diagram of a process for evaluating local pose estimation models for personalization.

FIG. 4B depicts a flow diagram of a process for training local pose estimation models based on personalized training data.

FIG. 4C depicts a flow diagram of a process for updating a generic pose estimation machine learning model based on training a local or personalized pose estimation model.

FIG. 5 depicts a flow diagram of a process leveraging confidence metrics to generate training data from pose estimation models.

FIG. 6 depicts a flow diagram of a process for evaluating frames to generate confidence metrics for training of local and generalized pose estimation models.

FIG. 7 depicts a flowchart depicting model weight aggregation of model parameters associated with a tuned model on computing devices associated with different users.

FIG. 8A depicts a schematic representing tuning of a local pose estimation model based on digital images corresponding to a user.

FIG. 8B depicts improvements in accuracy for a user's estimated pose over time based on training of a personalized pose estimation model.

FIG. 9 depicts errors in pose estimation mitigated by improved training of personalized pose estimation models.

FIG. 10 is a block diagram illustrating an example of a processing system in which at least some operations described herein can be implemented.

Various features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the technology. Accordingly, although specific embodiments are shown in the drawings, the technology is amenable to various modifications.

### DETAILED DESCRIPTION

Introduced here are computer-implemented platforms that are designed to improve adherence to, and success of, care programs that are assigned to users for completion. A care program (or simply “program”) may be designed for one or more musculoskeletal (MSK) conditions. As an example, a program may be designed in an effort to address (e.g., alleviate or lessen) the pain that tends to accompany a given MSK condition, as well as facilitate the continued engagement that is critical for long-term success. Specifically, the program may instruct, prompt, or otherwise elicit performance of physical activities that are meant to improve different aspects of the given MSK condition. Examples of physical activities include exercises, stretches, and the like.

As part of a program, a user may be requested to engage with a computer-implemented platform (also referred to as a “pose monitoring platform”) that is accessible via a computer program executing on a computing device. The term “user” may be used to generally refer to an individual who engages in physical activities via the pose monitoring platform. Over time, the user may be instructed to perform physical activities during physical activity sessions (or simply “sessions”) as part of a program. For example, the user may be instructed to perform a series of physical activities over the course of a session, and the user may be prompted to complete a series of sessions over the course of several days, weeks, or months. The pose monitoring platform may not only assist the user by actively guiding her through each session, but also help her achieve and maintain proper technique in performing the physical activities.

As further discussed below, a pose monitoring platform may represent one part of the physical activity system (or simply “system”) that is designed to promote compliance with a program by determining estimating poses performed by users via computer vision techniques. Though referred to in relation to therapeutic activities herein, the pose monitoring platform may promote programs with physical activities for a variety of activities beyond healthcare, such as for wellness, sports, dance, virtual reality, augmented reality, cooking, art, or any other endeavor that requires physical activities be performed in a particular manner (or simply benefits from physical activities being performed in a particular manner). More detailed examples of how monitoring pose can be helpful in different contexts are provided below.

Pose estimation commonly utilizes generalized models that are trained over datasets of digital images (or simply “images”) of posing users, as well as their corresponding actual poses. For example, a generalized model may be trained based on various digital images corresponding to frames of users posing in a variety of environments. Note that the term “frames” may be used to a series of digital images in temporal order, for example, that are collectively representative of a video. However, these generalized models may lose the ability to adapt to particularities of a given user's environment, as model weights may be trained to provide accurate results over many users, rather than for a particular user. Said another way, a generalized model may be designed and trained to be broadly applicable to a range of different scenarios (e.g., user characteristics and environment characteristics), but this generalization can harm accuracy as the generalized model is generally unable to account for the specificity of a given user's characteristics or the characteristics of her environment. For example, individual users may have unique clothes, physical attributes, or environments, such as unique objects in the background of a corresponding video. In some cases, a particular user's camera that is used to track poses may be damaged or modified in a manner that affects the accuracy of estimated poses for the given user as determined by the generalized model.

To improve the accuracy of personal pose estimation tasks, the pose monitoring platform described herein enables training of a pose estimation model associated with the user's computing device based on locally captured frames of a particular user. For example, the pose monitoring platform can determine (e.g., in real time) confidence metrics for frames captured by a camera that is trained on the user, where each confidence metric describes how likely an estimated pose determined for that frame corresponds to the user's actual pose. If there is low confidence in the accuracy of the estimated pose, the pose monitoring platform can generate an estimated pose using, for example, a more complex pose estimation model that is particular to the user's device. If this second estimated pose is likely more accurate, the pose monitoring platform can retrain the local pose estimation models accordingly. By doing so, the pose monitoring platform can personalize the pose estimation model for specific users, thereby improving the ability of the pose monitoring platform to capture users' individual poses and adapt to personal factors and/or contextual factors that affect such a determination. For example, the personalization can happen periodically (e.g., on daily, weekly, or monthly) for a determinate amount of time (e.g., one week, two weeks, three months) or an indeterminate amount of time, thereby enabling continual tuning of the pose estimation model.

Conventionally, pose estimation often requires computationally intensive models, as generating accurate poses can be a complex task. For example, pose estimation be performed by determining individual body parts in an image utilizing bounding boxes, and detecting the location of body parts within the bounding boxes. Because there is substantial variation and biological complexity in anatomical parts across users, conventional processing systems tasked with monitoring pose—when tasked with learning to estimate pose—require a large number of model parameters (e.g., the weights of a neural network) in order to generate estimated poses with satisfactory accuracy based on large amounts of training data. As such, conventional processing systems struggle to operate in real time with high accuracy, thereby precluding more accurate pose estimation models to post-processing tasks. Thus, conventional pose estimation models may struggle to issue accurate predictions in real time, rendering generation of real-time advice or recommendations for physical activities or physical therapy difficult. Simply put, conventional processing systems tend to struggle in applying conventional pose estimation models in real time because the demands for computational resources are high, often higher than the computing devices (e.g., mobile phones and tablet computers) in which these conventional processing systems are installed are able to provide.

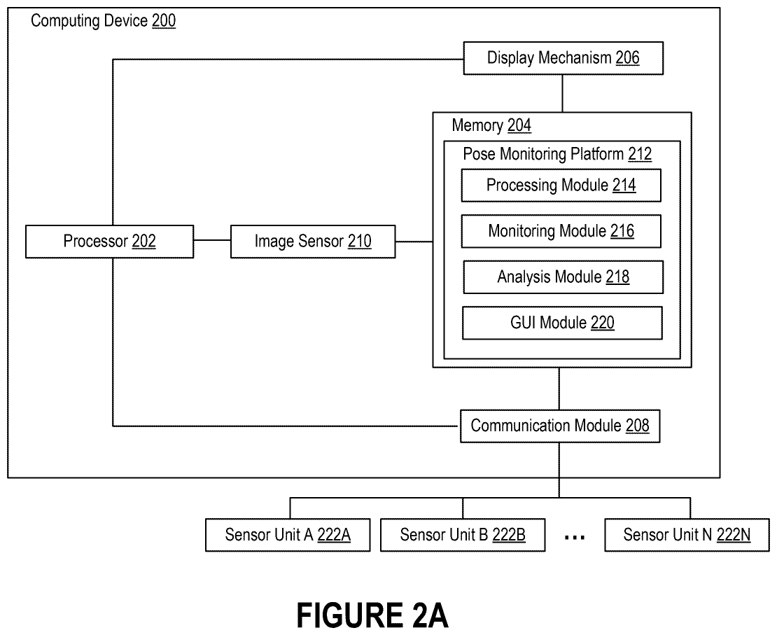

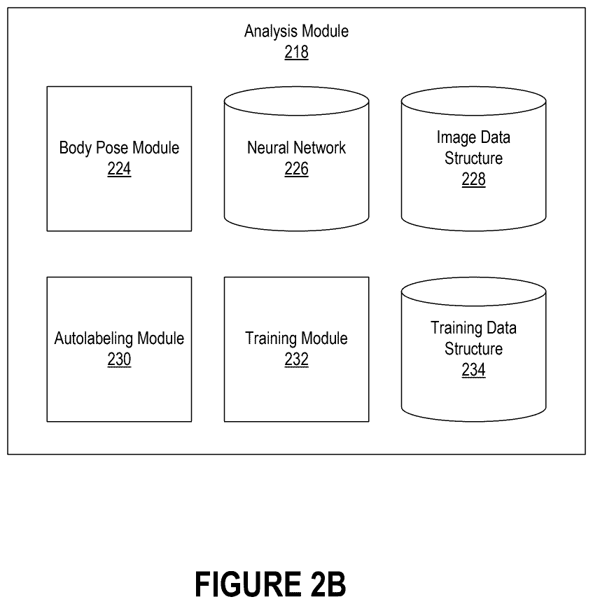

In order to improve the performance of real-time pose estimation, the pose monitoring platforms (e.g., as executed by processor 202 of FIG. 2A) disclosed herein leverage individualized models that can run on computing devices with less computational resources available. For example, the pose monitoring platform can utilize a “lightweight” pose estimation model (also called the “lightweight model” or “light model”) that is based on a subset of model parameters from a more complex, generalized pose estimation model (also called the “generalized model” or “base model”). In order to improve the accuracy of such a lightweight model, the pose monitoring platform can evaluate the lightweight model and generate improved, personalized predictions after real-time operation using a more complex model (e.g., also called the “heavyweight model” or “heavy model.” For instance, where there is unsatisfactory confidence that a pose estimated by the lightweight model corresponds to the user's actual pose, the pose monitoring platform can process the corresponding digital image through a more complex model as a background process. This background process may have more relaxed performance requirements than the lightweight model, while conferring improved accuracy to the pose monitoring platform. A training module within the pose monitoring platform can then update the lightweight model based on training data generated from this heavyweight model if this heavyweight model's output is determined to likely correspond to the user's actual pose. By doing so, the training module can leverage more performance-heavy models in order to improve the accuracy of the lightweight model iteratively while maintaining a relatively low performance footprint for this lightweight model. Thus, the pose monitoring platform disclosed herein enables improved accuracy for operation of the lightweight model during pose monitoring tasks, in real time, without greater computing device performance requirements.

In conventional processing systems, pose estimation, particularly for medical applications, may require user data that is subject to privacy concerns. For example, images or videos of patients may be classified as protected health information and, as such, may be unavailable to be used as training data for conventional pose estimation models. Thus, these conventional pose estimation models may be limited in sources of training data, which can harm the accuracy of these conventional pose estimation models and reduce the ability of these conventional pose estimation models to adapt to new users of such services. For example, a pose estimation model that relies on a complex model stored on a network-accessible server system—commonly referred to as the “cloud”—may not be allowed to receive images of users and their environments for training, as this may be subject to protection. Thus, such a pose estimation model is not able to leverage or adapt to new data, thereby reducing the effectiveness of the pose estimation model.

In order to improve pose estimation models' access to training data, the pose monitoring platforms disclosed herein enable updating and training models based on locally-determined model parameters. For example, a pose monitoring platform implemented by a processing system can evaluate whether an estimated pose based on a local pose estimation model is likely accurate and corresponds to an actual pose. Based on this determination, the pose monitoring platform can re-train the local pose estimation models, so as to personalize each local pose estimation model and improves its applicability to the particular user. Additionally or alternatively, the pose monitoring platform can send updated model parameters corresponding to these local models to a generalized model in a server, for example, to improve parameters associated with the generalized model. By doing so, the pose monitoring platform enables improvements in the accuracy of estimated poses without requiring transmission of digital images or any other personal information. Thus, the pose monitoring platform enables training of a generalized model for pose estimation by proxy, based on training a distinct, personalized model within a given user's computing device, thereby reducing any data-related privacy concerns. Using these improvements to the generalized model, the pose monitoring platform can update local pose estimation models (e.g., lightweight models and/or heavyweight models) on users' computing devices over time, thereby improving the accuracy of local pose estimation models, as well.

Generally, the pose monitoring platform described herein is embodied as a computer program executing on a computing device that is accessible to a user. This computing device can be coupled to one or more image sensors that capture data about the environment surrounding a user. As the user completes physical activities during a session, the computing device sends image data captured by these image sensors to the pose monitoring platform for computer vision analysis. By analyzing this image data, the pose monitoring platform may be able to establish whether the user is performing the physical activities as requested (e.g., by determining poses of body parts). This approach is lightweight and can be applied on a previously-cropped image patch, which only marginally increased the total runtime of the pose estimation model compared to a model that does not employ a secondary branch. Moreover, the approach is dedicated to determining body part presence or absence and therefore provides a complementary signal to keypoint detection confidence. Such an approach enables the pose monitoring platform to provide personalized feedback to a user about the physical activities that the user has performed. Moreover, the pose monitoring platform may tailor a program (or individual sessions) based on its knowledge of user movement. For example, if the pose monitoring platform determines that a user struggled to perform a physical activity (e.g., based on determined body poses), then the pose monitoring platform may issue further instructions to the user of how to properly perform the physical activity. At a high level, the pose monitoring platform is representative of a pathway for digitally engaging users in a consistent, meaningful way. As further discussed below, other avenues of communication may be employed as well. For example, a coach may be able to interact directly with users (e.g., via text messages, email, video, etc.) in addition to communicating with those users through the pose monitoring platform. The term “coach” may be used to generally refer to individuals who prompt, encourage, or otherwise facilitate engagement by users with programs. Similarly, users could be connected with healthcare professionals such as physical therapists, physicians, nurses, counselors, etc. For example, the pose monitoring platform may generate interfaces through which a coach can serve as a guide, partner, or “cheerleader” for a user as she completes sessions in accordance with a program. Similarly, the pose monitoring platform may generate interfaces through which a healthcare professional can obtain or rely on advice regarding symptoms, treatment, and the like.

As mentioned above, the approaches introduced here for estimating pose could be used across different applications. Accordingly, while embodiments may be described in the context of healthcare, features of those embodiments may be similarly applicable to other fields related to performing physical activities. Similarly, while embodiments may be described in the context of “coaches,” features of those embodiments may be similarly applicable to other professionals. In addition to, or instead of, facilitating communication with coaches and healthcare professions, the pose monitoring platform could facilitate communication with athletes, athletics coaches, dance instructors, chefs, cooking instructors, art instructors, and the like.

For the purpose of illustration, embodiments may be described with reference to particular anatomical regions, sensor data analysis techniques, pose applications (e.g., dance, therapy, sports, etc.), and the like. However, those skilled in the art will recognize that the features are similarly applicable to other anatomical regions, computer vision techniques, and use cases. As an example, while embodiments may be described in the context of an image sensor that captures image data about the environment around a user, the features described herein may be applied by a physical activity system having any number of image sensors arranged throughout the environment. In fact, a pose monitoring platform may establish the spatial position of different anatomical regions over time and then determine whether those spatial positions indicate that the physical activities were performed properly. For example, an image sensor that is embedded in a computing device (e.g., a mobile phone or tablet computer) may be used for capturing image data of a user playing a virtual reality game, or an image sensor may be affixed to the top of a television for capturing image data of a user playing a virtual reality game. The pose monitoring platform may be able to infer whether the user dodged monsters in the virtual reality game based on the image data captured by the image sensor. In another example, two image sensors may be placed in a kitchen, one above the island and the other above the stove. The pose monitoring platform may use image data of a user's hands captured by either sensor to determine if a user is using proper technique when chopping and sauteing zucchini. The pose monitoring platform may employ any number of computer vision techniques for determining body poses in these scenarios. Examples of computer vision techniques include image classification, object detection, object tracking, semantic segmentation, and instance segmentation.

Moreover, embodiments may be described in the context of computer-executable instructions for the purpose of illustration. However, aspects of the technology can be implemented via hardware, firmware, or software. As an example, a pose monitoring platform may be embodied as a computer program that offers support for completing sessions as part of a program, enables communication between users and coaches, and determines which physical activities are appropriate for a session given past performance, specified preferences, etc.

### Terminology

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense. That is, in the sense of “including but not limited to.” The term “based on” is also to be construed in an inclusive sense. Thus, unless otherwise noted, the term “based on” is intended to mean “based at least in part on.”

The terms “connected,” “coupled,” and variants thereof are intended to include any connection or coupling between two or more elements, either direct or indirect. The connection or coupling can be physical, logical, or a combination thereof. For example, elements may be electrically or communicatively coupled to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

### Overview of Pose Monitoring Platform

As discussed above, a pose monitoring platform may be responsible for guiding a user through sessions that are performed as part of a program. As part of the program, the user may be requested to engage with the pose monitoring platform on a periodic basis. The frequency with which the user is requested to engage with the pose monitoring platform may be based on factors such as the anatomical region for which therapy is needed, the MSK condition (or non-healthcare related condition, such as desire to improve technique) for which therapy is needed, the difficulty of the program, the age of the user, the amount of progress that has been achieved, and the like.

The pose monitoring platform may perform three-dimensional (3D) pose estimation, where a pose comprises 3D locations in an image of joints in a body (e.g., elbows) and of body parts (e.g., face, hands, etc.). For accuracy, the pose monitoring platform performs pose estimation in a top-down manner by detecting body part instances in an image, cropping the body part instances out of the image, and processing the crops using a model. The model may be trained on images of body parts, so without a branch to determine whether an image includes a body part, the model may “hallucinate” by assuming that each image includes a body part and outputting an estimated pose even if the image does not contain a body part. To alleviate this hallucination effect, the model includes a first branch for predicting body part presence along with a second branch for estimating pose. The first branch provides an added layer of prediction to the model and outputs higher scores for an image that includes a body part than for an image that does not.

As mentioned above, the pose monitoring platform may estimate pose in contexts that are unrelated to healthcare, for example, to improve technique. For example, the pose monitoring platform may estimate pose of an individual while she completes an athletic activity (e.g., dancing, shooting a basketball, throwing a baseball), a virtual reality activity, an augmented reality activity, a cooking activity, an art activity, etc. Accordingly, while embodiments may be described in the context of a “user,” the features of those embodiments may be similarly applicable to individuals performing physical activities. These individuals may also be referred to as “users” of the pose monitoring platform.

Even if the pose monitoring platform is able to request that a user engage at a given frequency, the user will normally have the autonomy to engage with the program as frequently as she desires. Thus, the user may define a schedule for completing sessions (e.g., every day, every other day, or twice per week) as further discussed below, and various features of the pose monitoring platform may be designed in support of this habit formation. Alternatively, the user may complete sessions on an ad hoc basis.

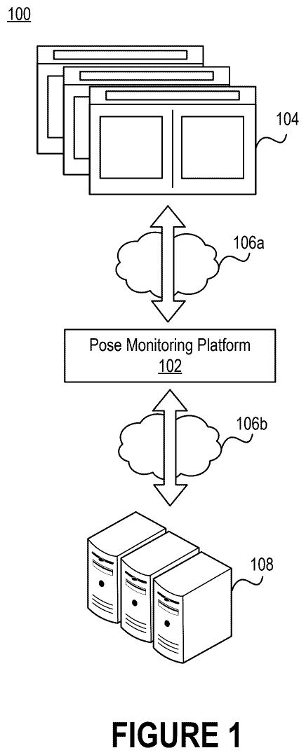

FIG. 1 illustrates an example of a network environment 100 that includes a pose monitoring platform 102. Individuals can interact with the pose monitoring platform 102 via interfaces 104 as further discussed below. For example, users may be able to access interfaces that are designed to guide them through sessions, present educational content, indicate progression in a program, present feedback from coaches, etc. As another example, coaches may be able to access interfaces through which information regarding completed sessions (and thus program progression) and clinical data can be reviewed, feedback can be provided, etc. Thus, interfaces 104 generated by the pose monitoring platform 102 may serve as informative spaces for users or coaches, or the interfaces 104 generated by the pose monitoring platform 102 may serve as collaborative spaces through which users and coaches can communicate with one another.

As shown in FIG. 1, the pose monitoring platform 102 may reside in a network environment 100. Thus, the computing device on which the pose monitoring platform 102 is executing may be connected to one or more networks 106a-b. The networks 106a-b can include personal area networks (PANs), local area networks (LANs), wide area networks (WANs), metropolitan area networks (MANs), cellular networks, the Internet, etc. Additionally or alternatively, the computing device can be communicatively coupled to other computing devices over a short-range wireless connectivity technology, such as Bluetooth®, Near Field Communication (NFC), Wi-Fi® Direct (also referred to as “Wi-Fi P2P”), and the like. As an example, the pose monitoring platform 102 is embodied as a mobile application that is executable by a mobile phone or tablet computer in some embodiments. In such embodiments, the mobile phone or tablet computer may be communicatively connected to (i) one or more sensor units via a short-range wireless connectivity technology and (ii) a computer server via the Internet.

The interfaces 104 may be accessible via a web browser, desktop application, mobile application, or over-the-top (OTT) application. For example, a user may be able to access interfaces that are designed to guide her through a session in which predetermined physical activities (e.g., exercises) are to be performed a predetermined number of times via a mobile application that is executing on a mobile phone or tablet computer. As another example, a coach may be able to access interfaces through which she can review the progress of one or more users via a web browser executing on a tablet computer or laptop computer. As another example, a coach may be able to access interfaces through which she can personalize users' sessions based on, for example, their needs and progress. Accordingly, the interfaces 104 may be viewed on various computing devices depending on the nature of the pose monitoring platform 102 and its deployment. Examples of computing devices include desktop computers, laptop computers, tablet computers, mobile phones, wearable electronic devices (e.g., watches or fitness accessories), mobile workstations (also referred to as “computer carts”), network-connected electronic devices (e.g., televisions or home assistant devices), and virtual or augmented reality systems (e.g., head-mounted displays).

In some embodiments, at least some components of the pose monitoring platform 102 are hosted locally. That is, part of the pose monitoring platform 102 may reside on the computing device used to access one of the interfaces 104. For example, the pose monitoring platform 102 may be embodied as a mobile application executing on a mobile phone or tablet computer. In such embodiments, the instructions that, when executed, implement the pose monitoring platform 102 may reside largely or entirely on the mobile phone or tablet computer. Note, however, that the mobile application may be able to access a server system 108 on which other components of the pose monitoring platform 102 are hosted.

In other embodiments, the pose monitoring platform 102 is executed entirely by a cloud computing service operated by, for example, Amazon Web Services®, Google Cloud Platform™, or Microsoft Azure®. In such embodiments, the pose monitoring platform 102 may reside on a server system 108 comprised of one or more computer servers that are accessible via a network (e.g., the Internet). These computer servers can include information regarding different programs, sessions, or physical activities; computer-implemented models (or simply “models”) that indicate how anatomical regions should move when a given physical activity is performed; algorithms for processing data from which spatial position or orientation of anatomical regions can be computed, inferred, or otherwise determined; user data such as name, age, weight, ailment, enrolled program, duration of enrollment, number of sessions completed, and correspondence with coaches; and other assets.

Those skilled in the art will recognize that this information could also be distributed amongst a network-accessible server system and one or more computing devices. For example, some user data may be stored on, and processed by, her own computing device for security and privacy purposes. This information may be processed (e.g., encrypted or obfuscated) before being transmitted to the server system 108. As another example, some user data may be retrieved from an electronic health record (also referred to as an “electronic medical record”) that is maintained for the user. Electronic health records are normally maintained in storage that is managed by healthcare systems, and this storage may be accessible to the pose monitoring platform 102 (e.g., via an application programming interface). As another example, the algorithms and models needed to process the data from which the spatial position or orientation of anatomical regions of a given individual can be computed, inferred, or otherwise determined may be stored on, or accessible to, a computing device associated with the given individual to ensure that such data can be processed in real time (e.g., as physical activities are performed as part of a session). The data could be generated by one or more sensor units that are secured to the human body of the given individual (e.g., proximate to the anatomical regions), or the data could be generated by a camera that is included in, or accessible to, the computing device used by the given individual to initiate the session.

FIG. 2A illustrates an example of a computing device 200 that is able to implement a program in which a user is requested to perform physical activities, such as exercises, during sessions by a pose monitoring platform 212. In some embodiments, the pose monitoring platform 212 is embodied as a computer program that is executed by the computing device 200. In other embodiments, the pose monitoring platform 212 is embodied as a computer program that is executed by another computing device (e.g., a computer server) to which the computing device 200 is communicatively connected. In such embodiments, the computing device 200 may transmit data captured by the image sensor 210 to the other to the other computing device for processing. Those skilled in the art will recognize that aspects of the computer program could also be distributed amongst multiple computing devices.

The computing device 200 can include a processor 202, memory 204, display mechanism 206, communication module 208, and image sensor 210. Each of these components is discussed in greater detail below. Those skilled in the art will recognize that different combinations of these components may be present depending on the nature of the computing device 200.

The processor 202 can have generic characteristics similar to general-purpose processors, or the processor 202 may be an application-specific integrated circuit (ASIC) that provides control functions to the computing device 200. As shown in FIG. 2A, the processor 202 can be coupled to all components of the computing device 200, either directly or indirectly, for communication purposes.

The memory 204 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by the processor 202, the memory 204 can also store data generated by the processor 202 (e.g., when executing the modules of the pose monitoring platform 212) and produced, retrieved, or obtained by the other components of the computing device 200. For example, data received by the communication module 208 from the image sensor 210 (via the processor 202) or sensor units 222A-N may be stored in the memory 204, or data produced by the image sensor 210 may be stored in the memory 204. Note that the memory 204 is merely an abstract representation of a storage environment. The memory 204 could be comprised of actual memory integrated circuits (also referred to as “chips”).

The display mechanism 206 can be any mechanism that is operable to visually convey information to a user (e.g., a user). For example, the display mechanism 206 may be a panel that includes light-emitting diodes (LEDs), organic LEDs, liquid crystal elements, or electrophoretic elements. In some embodiments, the display mechanism 206 is touch sensitive. Thus, a user may be able to provide input to the pose monitoring platform 212 by interacting with the display mechanism 206.

The communication module 208 may be responsible for managing communications between the components of the computing device 200, or the communication module 208 may be responsible for managing communications with other computing devices (e.g., sensor units 220A-N of FIG. 2A or server system 108 of FIG. 1). The communication module 208 may be wireless communication circuitry that is designed to establish communication channels with other computing devices. Examples of wireless communication circuitry include chips configured for Bluetooth, Wi-Fi, NFC, and the like. Assume, for example, that the computing device 200 is associated with a user. In such a scenario, the communication module 208 may initiate and then maintain a communication channel with a network-accessible server system managed by a digital service that is responsible for enrolling and then engaging users in programs. Moreover, the communication module 208 may initiate and then maintain communication channels with one or more external image sensors and/or one or more sensor units 222A-N that are secured to different anatomical regions of the user. As further discussed below, data generated by these components may be streamed to the pose monitoring platform 212 during a session for analysis.

The image sensor 210 may be any electronic sensor that is able to detect and convey information in order to generate images, generally in the form of image data or pixel data. Examples of image sensors include charge-coupled device (CCD) sensors and complementary metal-oxide semiconductor (CMOS) sensors. The image sensor 210 may be implemented in a camera that is implemented in the computing device 200. In some embodiments, the image sensor 210 is one of multiple image sensors implemented in the computing device 200. For example, the image sensor 210 could be included in a front- or rear-facing camera on a mobile phone. In some embodiments, the image sensor may be externally connected to the computing device 200 such that the image sensor 210 captures image data of an environment and sends the image data to the processing module 214.

For convenience, the pose monitoring platform 212 may be referred to as a computer program that resides within the memory 204. However, the pose monitoring platform 212 could be comprised of software, firmware, or hardware implemented in, or accessible to, the computing device 200. In accordance with embodiments described herein, the pose monitoring platform 212 may include a processing module 214, monitoring module 216, analysis module 218 and graphical user interface (GUI) module 220. These modules can be an integral part of the pose monitoring platform 212. Alternatively, these modules can be logically separate from the pose monitoring platform 212 but operate “alongside” it. Together, these modules may enable the pose monitoring platform 212 to guide a user through sessions that are performed as a part of a program designed to improve performance of one or more physical activities or manage/treat an MSK condition that is affecting a particular anatomical region.

The processing module 214 can process image data obtained from the image sensor 210 over the course of a session. The image data may be used to infer a spatial position or orientation of the corresponding anatomical region. For example, the processing module 214 may perform operations (e.g., filtering noise, changing contrast, reducing size) to ensure that the data can be handled by the other modules of the pose monitoring platform 212. As another example, the processing module 214 may temporally align the data with data obtained from another source (e.g., the sensor units 222A-N or another image sensor) if multiple data are to be used to establish the spatial position or orientation of the anatomical regions of interest.

In some embodiments, the processing module 214 additionally or alternatively processes data obtained from sensor units 222A-N attached to anatomical regions of the user over the course of the session. The processing module 214 can parse, filter or otherwise alter this data so that it is usable by the other modules of the pose monitoring platform 212. As an example, in some embodiments, the processing module 214 may examine this data in order to ensure that multiple streams of data received from different components (e.g., Sensor Unit A 222A and Sensor Unit B 222B) are temporally aligned with one another.

Moreover, the processing module 214 may be responsible for processing information input by users through interfaces generated by the GUI module 220. For example, the GUI module 220 may be configured to generate a series of interfaces that are presented in succession to a user as she completes physical activities as part of a session. On some or all of these interfaces, the user may be prompted to provide input. For example, the user may be requested to indicate (e.g., via a verbal command or tactile command provided via, for example, the display mechanism 206) that she is ready to proceed with the next physical activity, that she completed the last physical activity, that she would like to temporarily pause the session, etc. These inputs can be examined by the processing module 214 before information indicative of these inputs is forwarded to another module.

The monitoring module 216 can monitor ongoing movement of the user as she completes physical activities as part of a session. While the processing module 214 may be responsible for processing data streamed to the pose monitoring platform 212 (e.g., by the image sensor 210 or, in some embodiments, the sensor units 222A-N), the monitoring module 216 may be responsible for determining whether the user is moving as would be expected when completing a physical activity. As an example, assume that the imager sensor 210 is positioned in front of a user. During a session, the user may be instructed to perform an exercise such as a side plank in which the hips are lifted away from the ground. In such a scenario, the monitoring module 216 can examine image data generated by the image sensor 210 to determine whether the thorax and lumbar regions of the user's body are moving—either in terms of three-dimensional (3D) space or with respect to one another—as would be expected given the exercise.

The analysis module 218 may be responsible for determining adherence to individual physical activities, sets of physical activities performed during sessions, or sets of sessions performed as part of a program. As shown in FIG. 2B, the analysis module 218 includes a body pose module 224, a neural network 226, an image data structure 228, an autolabeling module 230 a training module 232, and a training data structure 234. In some embodiments, the analysis module 218 may include a subset of the modules and data structures shown in FIG. 2B, or the analysis module 218 may include additional modules or data structures that are not shown in FIG. 2B.

The body pose module 224 may be responsible for determining estimated poses of body parts as users perform physical activities. Body parts may include any portion of a user's body used to perform a physical activity (e.g., hands, feet, torso, etc.). A body part may refer to a single anatomical region (e.g., a hand), one anatomical region in relation to another anatomical region (e.g., a hand in relation to an elbow), or a series of anatomical regions in relation to another anatomical region (e.g., fingers of a hand). Physical activities may include movements performed for wellness, sports, dance, virtual reality experiences, augmented reality experiences, physical therapy, or any other activity that requires physical movement. Some examples of physical activities include dance moves (e.g., pliss, moonwalks, shuffles, etc.), sporting techniques (e.g., football throws, soccer kicks, tennis serves, basketball layups, yoga poses, etc.), exercises (e.g., planks, hip extensions, etc.), stretches, posture techniques (e.g., standing/sitting at desk for healthy back and neck), and cooking techniques (e.g., chopping, kneading, dicing, etc.).

The body pose module 224 can obtain image data of an environment from the image sensor 210. The environment includes a user as she is performing one or more physical activities. In some embodiments, the image data may depict the user's entire body in the environment. In other embodiments, the image data may depict one or more of the user's body parts in the environment. For example, in one embodiment, the image data may only depict the hands and feet of the user. In some embodiments, the image data may depict body parts of multiple users. The body pose module 224 may store the image data in the image data structure 228 along with an indication of a time, date, or location associated with the capture of the image data.

In some embodiments, the image data structure 228 may be implemented on a computing device 200 where the image sensor 210 is located. In other embodiments, the image data structure 228 may be implemented in the server system of FIG. 1. The image data structure may be formatted to expedite pose analysis by the analysis module 218. For example, in some instances, the image data structure 228 may be tabulated by identifiers associated with the particular image sensor 210 that capture the image data, identifiers of the users depicted in or otherwise associated with the image data, and/or identifiers of a computing device 200 that transmitted the image data to the analysis module 218.

The body pose module 224 can extract one or more feature maps from the image data. In one embodiment, the body pose module 224 segments the image data into contiguous regions of pixels. Each contiguous region of pixels may be associated with a portion of the environment. In some embodiments, the body pose module 224 segments the image data based on objects shown in the image data. The term “feature map” may be used to refer to a vectorial representation of features in the image data. The body pose module 224 may extract feature maps by applying filters or feature detectors to each segment. The body pose module 224 may store the segments and associated feature maps in the image data structure 228 or another datastore.

The body pose module 224 can apply the neural network 226 to each extracted feature map. The neural network 226 may include a series of convolutional layers and a series of connected layers of decreasing size and the last layer of the neural network 226 may be a sigmoid activation function. The neural network 226 can include a plurality of parallel branches that are configured to together estimate poses of body parts based on the feature maps. A first branch of the neural network 226 could be configured to determine a likelihood that the portion of the environment associated with the segment includes a body part, while a second branch of the neural network 226 could be configured to determine an estimated pose of the body part in the portion of the environment associated with the segment. In some embodiments, the body pose module 224 may employ an additional or alternative machine-learning or artificial intelligence framework to the neural network 226 to estimate poses of body parts.

In some embodiments, the neural network 226 may include additional or alternative branches that the body pose module 224 employs together to determine a pose of a body part. For example, in some embodiments, the neural network 226 includes a set of branches for each possible body part that may be included in the segment. For example, the neural network 226 may include a set of hand branches that determine a likelihood that the segment includes a hand and estimated poses of hands in the segment. The neural network may similarly include a set of branches that detect right legs in the segment and determine poses of the right legs in the segment and another set of branches that detects and determines poses of left legs in the segment. Further, the neural network 226 may include branches for other anatomical regions (e.g., elbows, fingers, neck, torso, upper body, hip to toes, chest and above, etc.) and/or sides of a user's body (e.g., left, right, front, back, top, bottom). The neural network is further described below in relation to the training module 232.

For example, the body pose module 224 can generate estimated poses using one or more machine learning models designed and trained for pose estimation (also called “pose estimation models” or simply “models”), which can include the neural network 226 or any other neural network, artificial intelligence, or computer-based analytical method. For example, a machine learning model can be any software or hardware tool that can learn from data and make predictions, classifications, or inferences based on this data. In some embodiments, the machine learning model can include one or more algorithms, including supervised learning, unsupervised learning, semi-supervised learning, reinforcement learning, deep learning, neural networks, decision trees, support vector machines, and k-means clustering. For example, the machine learning model can be implemented as a convolutional neural network (or feed forward network, recurrent neural network, random forest, or xgboost model). The machine learning model can include any model that can accept, for example, one or more digital images and/or video frames as input. The machine learning model can infer a two-dimensional (“2D”) or three-dimensional (“3D”) representation of the pose of one or more users, for example, through the body pose module 224 and/or other similar techniques disclosed above. In some embodiments, the machine learning model can include a real-time or background confidence determination model, which can determine a probability that an estimated pose corresponds to an actual pose based on the associated digital image. Note that while embodiments may be described in the context of a “real-time or background confidence determination model,” those skilled in the art will recognize that the pose monitoring platform 212 may alternatively use an algorithm, rule, or heuristic to determine confidence in real time.

The one or more machine learning models utilized by the body pose module 224 can be trained, such as through the training module 232 using the training data structure 234, to execute inference operations. An inference operation can include an operation that accepts input (e.g., a digital image) and outputs a classification, a prediction, a score, or a dataset. In disclosed embodiments, an inference operation can output one or more datapoints that define an estimated pose, such as a 2D or a 3D representation of a user's body parts within a digital image. In some embodiments, an inference operation can include generation of a numerical score indicating confidence in an estimated pose by a real-time or background confidence determination model (e.g., a likelihood that the estimated pose corresponds to an actual pose of the user). For example, a machine learning model that is executing an inference operation can include a real-time or background confidence determination model, which can receive a digital image and a representation of an estimated pose as input and generate a probability that the first estimated pose corresponds to the actual pose of the user as output.

Machine learning models can include model parameters. A model parameter can include variables (including vectors, arrays, or any other data structure) that are internal to the model and whose value can be determined from training data. For example, model parameters can determine how input data is transformed into the desired output. As an illustrative example, in the case of a machine learning model leveraging the neural network 226, model parameters can include weights or biases for each neuron within each layer. In some embodiments, the weights and biases can be processed using activation functions for corresponding neurons, thereby enabling transformation of the input into a corresponding output. Model parameters can be determined using one or more training algorithms, such as those executed by the training module 232, using training data within the training data structure 234, as discussed below. For example, model parameters for models associated with the body pose module 224 can be trained or generated based on training data pertaining to a plurality of users, for example, in the case of a generic machine learning model. Additionally or alternatively, local versions of the machine learning model can include model parameters that are trained on data pertaining to a particular user or subset of users (either independently, or further trained based on the generic model's parameters). By personalizing such model parameters, the pose monitoring platform 212 can provide improved estimated poses that are more sensitive to a user's particular characteristics and/or environment.

In disclosed embodiments, the body pose module 224 and/or the autolabeling module 230 can transmit model parameters pertaining to other entities. For example, the pose monitoring platform 212 can transmit sets of model parameters corresponding to a local machine learning model for estimating a users' poses to an external server (e.g., server system 108) and/or another device, for further processing. By doing so, the pose monitoring platform 212 enables updating of generic model parameters based on local versions of models, as such local versions can rely on more personalized training data for model fine-tuning. In some cases, this personalized training data may not be available to external sources due to privacy concerns or regulatory constraints. As such, by transmitting updated model parameters to relevant entities, the pose monitoring platform 212 enables such trained model parameters to be leveraged in updating even generic models stored external to users' computing devices.

In disclosed embodiments, a pose monitoring platform 102 can update a model based on received model parameters. For example, the pose monitoring platform 212, which can reside on the server system 108, can receive one or more sets of model parameters from computing devices, where the computing devices can include local versions of machine learning models for pose estimation. The server system 108, using, for example, a training module 232 that resides on the server, can combine these model parameters to generate a set of average model parameters based on the one or more sets of model parameters. For example, each average model parameter can be representative of an average of a corresponding model parameter across the multiple sets of model parameters. The server system 108 can incorporate these model parameters into a generic version of the machine learning model for pose estimation, thereby improving the quality of estimated pose predictions by taking advantage of model parameters determined using local, personalized training data, despite not requiring direct receipt of such training data.

The pose monitoring platform 212 can reside on the server system 108. Additionally and/or alternatively, the pose monitoring platform 212 can reside on a user's computing device. A machine learning model residing on the server system 108 can be personalized and updated based on multiple users' estimated poses and corresponding training data, thereby comprising a generic machine learning model. A machine learning model, additionally or alternatively, can reside on a computing device and be personalized and/or updated based on a single user or a subset of users' estimated poses, thereby comprising a local version of a machine learning model.

In some embodiments, the body pose module 224 can include one or more machine learning models. The body pose module 224, for example, can include a lightweight model, and/or can include a heavyweight model. In disclosed embodiments, a heavyweight model and a lightweight model can include a machine learning model that can accept one or more images or video frames as input a 2D or 3D representation of a pose of one or more users withing the image or frame. A lightweight model can be configured to run in real time during image collection and/or processing on a user's computing device. For example, a lightweight model can be configured to operate within computational budgets (e.g., within a certain consumption level of random access memory and/or processing power) that enable operation during computationally intensive tasks, such as image collection. For example, a lightweight model that utilizes a neural network 226 can be configured to have a fewer number of hidden layers or model parameters than a heavyweight model.

A heavyweight model can include a machine learning model that is not constrained to operate during other computationally intensive tasks. For example, a heavyweight model can include a model that is configured to operate within a user's computing device, and can operate in the background when the computing device is not executing other computationally intensive tasks. In some embodiments, the heavyweight model operates within an operational budget of computational resources for a corresponding application or program. The heavyweight model that includes a neural network 226 can include more model parameters or hidden layers than a lightweight model, for example. By including a machine learning model with a larger computational budget than a lightweight model, the pose monitoring platform 212 enables improved accuracy and robustness for inferences (e.g., pose estimation operations) in comparison to a lightweight model. As such, the body pose module 224 can leverage lightweight models to provide short-term, relatively fast feedback to a user regarding pose, while the module can improve such predictions and, for example, generate training data for the lightweight model, in the background, without interfering with the operation of the user's computing device.

In some embodiments, for each indication, the body pose module 224 may cause the display mechanism 206 to display an indication that the user is performing the estimated pose with the body part. The body pose module 224 may do so in near real time. For example, the body pose module 224 may receive and segment image data and apply the neural network 226 to determine a pose of a body part as the user is performing the pose in real time. After performing such processing, the body pose module 224 may cause the display mechanism 206 to display the indication, allowing the user to move her body parts if she is aiming for a different pose. In some embodiments, the body pose module 224 may send indications to the GUI module 220 for display via the display mechanism 206, rather than directly causing the display mechanism 206 to display indications or other information.

In some embodiments, for each estimated pose, the body pose module 224 determines one or more physical activities associated with estimated pose. For instance, the body pose module 224 may access physical activities related to poses. For example, the pose “left-handed fist” may be associated with the physical activities “kickboxing jab,” “volleyball serve,” “hand therapy fist,” and “cooking utensil hold.” The body pose module 224 may access user data associated with the user (e.g., stored in memory of the pose monitoring platform 102 or accessed via a network by the pose monitoring platform 102). The body pose module 224 can select a physical activity from among the physical activities associated with the pose based on the user's data. For example, if the user's data indicates that she is undergoing therapy for her hand, the body pose module 224 may select the physical activity “hand therapy fist.” The body pose module 224 may cause the display mechanism 206 to display an indication of the physical activity to the user. In further embodiments, the body pose module 224 may access instructions for how the user could improve her technique (e.g., to achieve a therapeutic goal) for the physical activity based on the pose and cause the display mechanism 206 to display the instructions to the user. For example, if the body pose module 224 determines that, while kickboxing, the user is posing her hand in a fist with her thumb enclosed by her fingers, the body pose module 224 may cause the display mechanism 206 to display instructions for the user move her thumb to rest on the outside of her fingers.

In some embodiments, the body pose module 224 can determine whether a physical activity was successfully completed by the user based on estimated body poses. For example, if an estimated body pose does not match the physical activity that a user is supposed to be doing (e.g., determined based on user data), then the body pose module 224 may prevent further progression through a session hosted by the pose monitoring platform 102 until the physical activity is determined to have been performed with one or more certain poses. In another example, the body pose module 224 may update the session based on the estimated body pose to further teach the user how to perform the body pose if the user has not matched a pattern representative of a first athletic activity. The body pose module may also update the session to focus on a second activity upon to determining that the body pose does match the pattern.

The training module 232 can train a first branch (or a first set of branches that determine likelihoods, in some embodiments) of the neural network 226 to determine whether image data contains body parts. The training module 232 may obtain a set of digital images from the pose monitoring platform 102 or from a computing device connected to the pose monitoring platform 102. The training module 232 can determine, based on locations in the set of digital images, spatial positions of one or more body parts in each of the set of digital images. In one embodiment, the training module 232 may use an object detection model (also called an “object detector”), object recognition model (also called an “object recognizer”), or another computer vision technique to determine spatial positions of body parts. For each body part detected in the set of images, the training module 232 can place a bounding box around the body part in each image. The training module 232 can then iteratively displace the bounding box within the image until the bounding box no longer surrounds spatial positions associated with the body part. For each displaced instance of the bounding box, the training module 232 can add the portion of the image associated with (e.g., enclosed by) the bounding box, to a first set of training data stored in the training data structure 234. The training module 232 can then train the first branch (or the first set of branches) on the first set of training data.

In some embodiments, the training module 232 causes a display mechanism 206 of a computing device 200 associated with an external operator to display each digital image in the set. The training module 232 may receive interactions made by the operator via a GUI of the display mechanism 206, where one or more of the interactions indicate placement of bounding boxes around body parts in the digital images and includes labels for the bounding boxes with poses of an included body part. The training module 232 can add the portion of the image associated with each bounding box to a second set of training data in the training data structure 234. The training module 232 can then train the second branch of the neural network 226 on the second set of training data. In embodiments where the neural network includes a set of branches for each body part, the training module 232 can train the branches configured to estimate a pose of the body part on the second set of training data.

The training module 232 trains the neural network on the training data. In some embodiments, the training module 232 may retrain the neural network 226 each time new images are added to the training data. In other embodiments, the training module 232 may retrain the neural network 226 in response to a determination that at least a predetermined number of new images have been added to the training data. In further embodiments, the training module 232 may separate the training data based on the body part shown in each bounding box and train branches of the neural network 226 on training data corresponding to a particular body part (e.g., the branch trained for recognizing the pose of a foot is trained on images of feet).

In some embodiments, the body pose module 224 can generate training data (e.g., within the training data structure 234) based on estimated poses generated by the body pose module 224. For example, the body pose module 224 can analyze received digital images, such as digital images received through the image sensor 210 and determine estimated poses using processing module 214 during monitoring (e.g., using the neural network 226). In some embodiments, the body pose module 224, through monitoring module 216, can generate these estimated poses in real time on successive frames being captured, as described above. Based on such digital images, the body pose module 224 can generate an estimated pose for the user at successive times. In some embodiments, body pose module 224 can submit these estimated poses, as well as the corresponding digital images, to the autolabeling module 230.

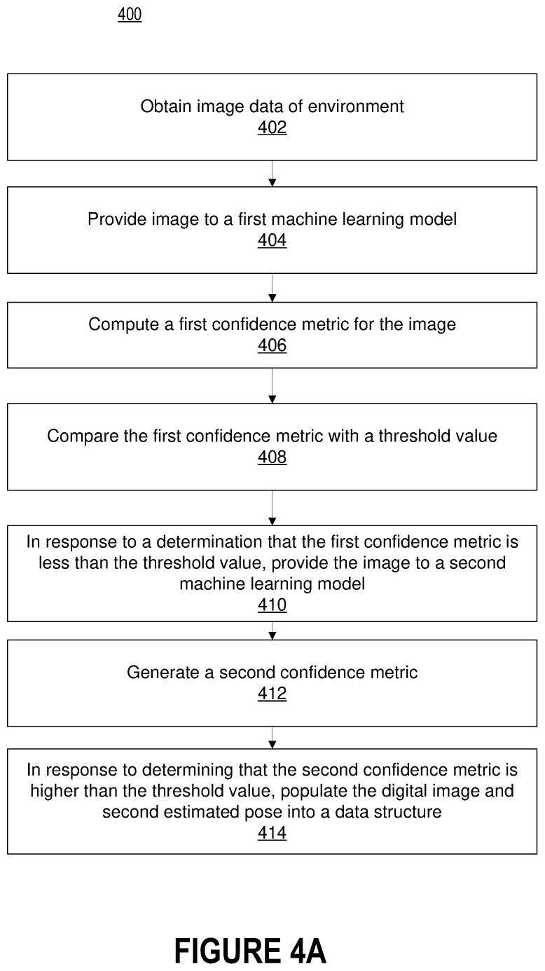

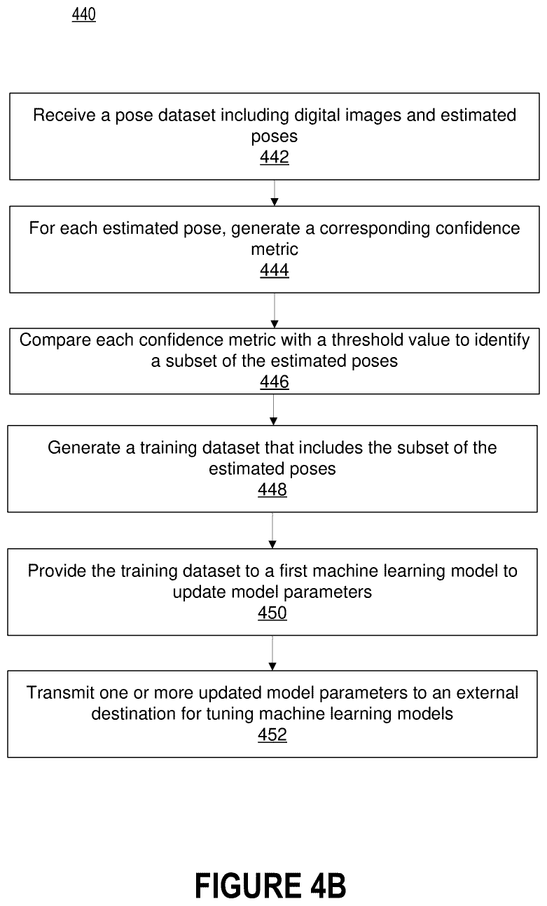

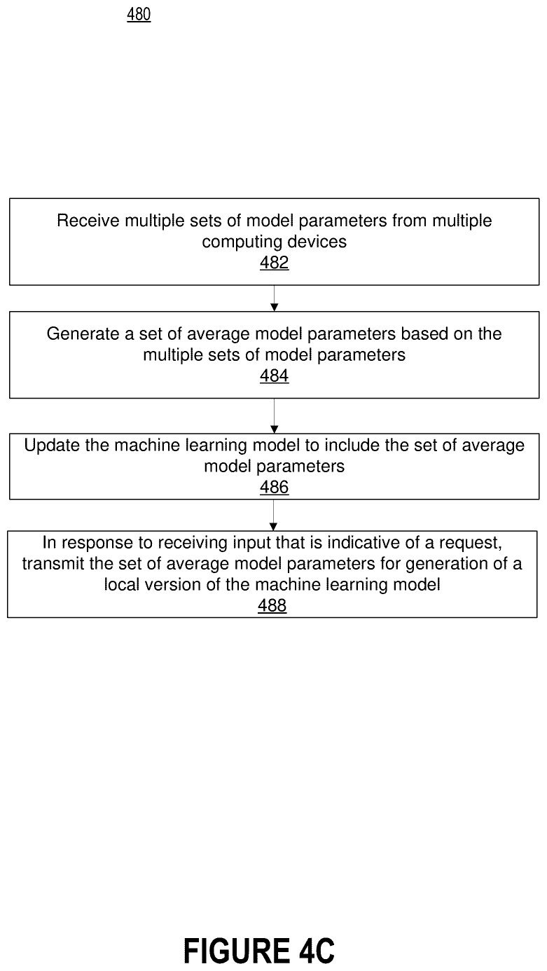

An autolabeling module 230 can generate confidence metrics. For instance, the autolabeling module 230 can label estimated poses and their corresponding digital images with a confidence metric, as discussed further in relation to FIG. 4A below. As an illustrative example, the autolabeling module 230 can determine a confidence metric that is indicative of a likelihood that an estimated pose corresponds to an actual pose of the user. Such a confidence metric can include a probability, such as a probability that the estimated pose is biologically or physically possible, or a probability that the estimated pose, based on the user's characteristics and/or environment, is consistent with the received digital image. In some embodiments, the autolabeling module 230 can generate more than one confidence metric for a given digital image and estimated pose, such as for different portions or regions of the digital image or corresponding estimated pose. In some embodiments, the autolabeling module 230 can generate confidence metrics for estimated poses generated by any one or more machine learning models, including generic and local versions of machine learning models, as well as heavyweight and/or lightweight versions of such models.

For example, the autolabeling module 230 can utilize a machine learning model, such as those described above (e.g., a model that utilizes a neural network 226), in order to generate confidence metrics. For example, the autolabeling module can comprise a real-time confidence determination model, which can include a machine learning model that can determine confidence metrics during digital image acquisition and/or processing. Additionally or alternatively, the autolabeling module 230 can determine confidence metrics subsequent to image acquisition and/or processing, such as through a background confidence determination model. The confidence determination model can reside within a computing device 200 or user terminal. Alternatively or additionally, the confidence determination model can reside within the server system 108.

The autolabeling module 230 and/or confidence determination model can generate confidence metrics based on estimated poses and digital images that represent a user's actual pose. An actual pose can include an actual 3D or 2D representation of a user's body pose, such as a representation that accurately depicts the location and/or placement of one or more body parts. For example, an actual pose can include a representation of a user performing a particular yoga pose that represents the user's ground-truth placement of hands, limbs and head. Note that an estimated pose need not correspond exactly to the actual pose for the autolabeling module to determine a high level of confidence in the estimated pose. For example, the estimated pose can include a low-resolution or coarse version of the actual pose that substantially represents the actual pose, without representing fine features of the actual pose. Information regarding an actual pose can be provided manually (e.g., through manual labeling of digital images with their actual poses) in order to produce training data for the autolabeling module, for example. As an illustrative example, training data for the autolabeling model includes a degree to which a generated skeletal frame (e.g., as represented by lines on an image) for a user corresponds to a skeletal frame defined for the actual pose required as part of a performance of a given activity.

In some embodiments, the autolabeling module 230 can generate confidence metrics using variations of digital images provided the system (e.g., image transformations), and/or variations in model parameters applied to the corresponding machine learning model (e.g., variations of one or more model parameters), as discussed in relation to FIG. 4A below.

The autolabeling module 230 can compare confidence metrics with one or more threshold values. For example, the autolabeling module 230 can receive a digital image and a corresponding estimated pose, as estimated by a machine learning model within the body pose module 224. The autolabeling module 230, using a real-time confidence determination model, determine a confidence metric, where the confidence metric indicates a probability (e.g., between zero and one) that the estimated pose corresponds to an actual pose of the corresponding user. The autolabeling module 230 can compare this confidence metric with a threshold value, which can also be between zero and one, in order to make a determination as to whether the estimated pose likely corresponds to the actual pose of the user. The threshold value can be determined manually. In some embodiments, the threshold value can be determined based on information regarding one or more characteristics of the environment and/or user. For example, the body pose module 224 can determine that one or more sensor units 222A-222N are faulty and/or the environment is of a low-light environment and, therefore, that the threshold value can be lowered in order to account for any possible ablations, defects, or issues in the digital image quality. Alternatively or additionally, the body pose module 224 can determine that, due to very strong contrast and/or feature definition within the corresponding digital image, the threshold value can be increased to require higher confidence prior to confidence determination.

Based on comparing a digital image's confidence metric with the threshold value, the autolabeling module 230 can generate a confidence indicator. The confidence indicator can, for example, include a discrete value (e.g., either a zero or a one) indicating whether the autolabeling module 230 has determined that a corresponding estimated pose is consistent with (e.g., corresponds to) an actual pose of the user based on how the confidence metric compares with the threshold value. The autolabeling module 230 can store such confidence indicators, as well as the corresponding digital image and estimated pose, using a training data structure 234 within the memory 204. By generating such confidence indicators, the autolabeling module enables generation of training data for training models associated with the body pose module 224. For example, the autolabeling module 230 can store a set of combinations of digital images and corresponding estimated poses that are deemed to be high confidence and transmit this subset to the body pose module 224 for further training of the lightweight, heavyweight and/or generic machine learning models (e.g., as a training dataset). By doing so, the autolabeling module 230 enables generation of high-quality training data with limited-to-no real-time manual input.

In some embodiments, for estimated poses with poor confidence (e.g., a confidence metric lower than the threshold), the autolabeling module 230 can determine to transmit these estimated poses and corresponding digital images to the same or another machine learning model (e.g., the heavyweight model) to generate updated predictions for the estimated poses that are more accurate. By doing so, the autolabeling module 230 enables generation of improved predictions and can subsequently train the lightweight model accordingly, even if such training and improved predictions may be infeasible for a lightweight model during real-time data acquisition and processing.

In some embodiments, the autolabeling module 230 can transmit or receive (e.g., to or from a plurality of computing devices) multiple sets of model parameters that were updated using corresponding sets of combinations of digital images and corresponding estimated poses deemed to be high confidence. The autolabeling module 230 can generate, for example, an average confidence metric associated with each subset and compare this average confidence metric to a threshold metric to determine a subset of these combinations that can be stored as a training dataset for training of, for example, a generic machine learning model (or any other machine learning model). For example, the average confidence metric can include an average of multiple confidence metrics that are indicative of likelihoods that estimated poses correspond to actual poses of users. By doing so, the training module 232 can leverage more accurate training data for further updating and training of machine learning models.

The autolabeling module 230 can determine one or more model performance metrics corresponding to a machine learning model. For example, the autolabeling module 230 can generate a model performance metric by indicating an average confidence metric for estimated poses (and corresponding digital images) that were output or provided by a given machine learning model using the corresponding model parameters. In some embodiments, the system can generate this model performance metric for more than one version of the same machine learning model (e.g., two versions of the same machine learning model, each with different model parameters). By doing so, the autolabeling module 230 can track the performance of machine learning models over time and, if beneficial to model performance, revert model parameters to those of a previous version of the machine learning model.

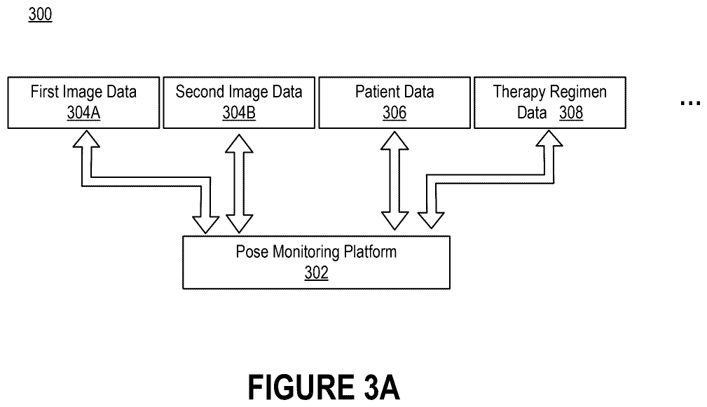

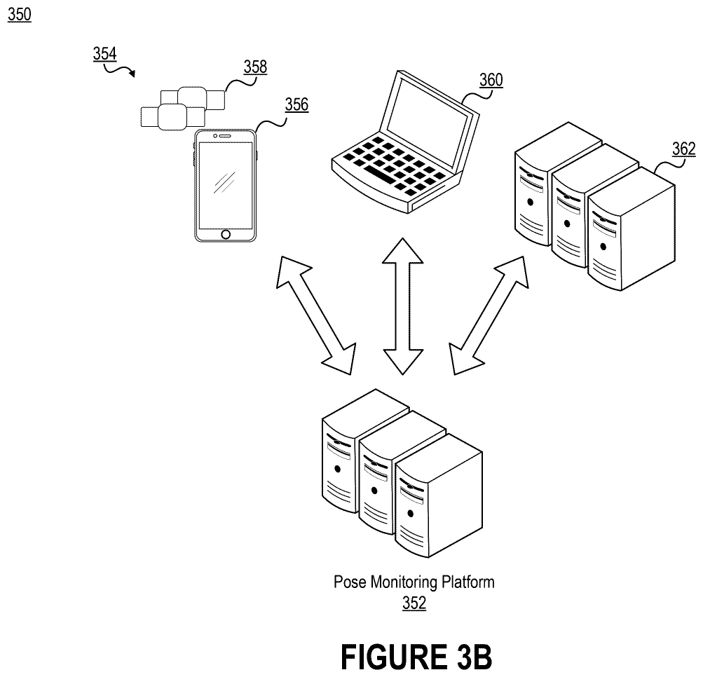

FIG. 3A depicts an example of a communication environment 300 that includes a pose monitoring platform 302 configured to receive several types of data. Here, for example, the pose monitoring platform 302 receives first image data 304A that captured by a first image sensor (e.g., image sensor 210 of FIG. 2A) located in front of a user, second image data 304B generated by a second image sensor located behind a user, user data 306 that is representative of information regarding the user, and therapy regimen data 308 that is representative of information regarding the program in which the user is enrolled. Those skilled in the art will recognize that these types of data have been selected for the purpose of illustration. Other types of data, such as community data (e.g., information regarding adherence of cohorts of users), could also be obtained by the pose monitoring platform 302.

These data may be obtained from multiple sources. For example, the therapy regimen data 308 may be obtained from a network-accessible server system managed by a digital service that is responsible for enrolling and then engaging users in programs. The digital service may be responsible for defining the series of physical activities to be performed during sessions based on input provided by coaches. As another example, the user data 306 may be obtained from various computing devices. For instance, some user data 306 may be obtained directly from users (e.g., who input such data during a registration procedure or during a session), while other user data 306 may be obtained from employers (e.g., who are promoting or facilitating a wellness program) or healthcare facilities such as hospitals and clinics. Additionally or alternatively, user data 306 could be obtained from another computer program that is executing on, or accessible to, the computing device on which the pose monitoring platform 302 resides. For example, the pose monitoring platform 302 may retrieve user data 306 from a computer program that is associated with a healthcare system through which the user receives treatment. As another example, the pose monitoring platform 302 may retrieve user data 306 from a computer program that establishes, tracks, or monitors the health of the user (e.g., by measuring steps taken, calories consumed, or heart rate).

FIG. 3B depicts another example of a communication environment 350 that includes a pose monitoring platform 352 configured to obtain data from one or more sources. Here, the pose monitoring platform 352 may obtain data from a therapy system 354 comprised of a tablet computer 356 and one or more sensor units 358 (e.g., image sensors), personal computer 360, or network-accessible server system 362 (collectively referred to as the “networked devices”). For example, the pose monitoring platform 352 may obtain data regarding movement of a user during a session from the therapy system 354 and other data (e.g., therapy regimen information, models of exercise-induced movements, feedback from coaches, and processing operations) from the personal computer 360 or network-accessible server system 362.

The networked devices can be connected to the pose monitoring platform 352 via one or more networks. These networks can include PANs, LANs, WANs, MANs, cellular networks, the Internet, etc. Additionally or alternatively, the networked devices may communicate with one another over a short-range wireless connectivity technology. For example, if the pose monitoring platform 352 resides on the tablet computer 356, data may be obtained from the sensor units over a Bluetooth communication channel, while data may be obtained from the network-accessible server system 362 over the Internet via a Wi-Fi communication channel.

Embodiments of the communication environment 350 may include a subset of the networked devices. For example, some embodiments of the communication environment 350 include a pose monitoring platform 352 that obtains data from the therapy system 354 (and, more specifically, from the sensor units 358) in real time as physical activities as performed during a session and additional data from the network-accessible server system 362. This additional data may be obtained periodically (e.g., on a daily or weekly basis, or when a session is initiated).

### Personalized Pose Estimation Process

FIG. 4A depicts a flow diagram 400 of a process for evaluating personalized local pose estimation models using one or more components or modules described herein.

At step 402, the pose monitoring platform 212 can obtain image data of an environment associated with a user, including a user's body, clothes, and/or objects within the background or foreground of the image. For example, the monitoring module 216 can receive, from a camera included in the computing device, a digital image of an environment in which a user is posed. In some instances, the platform can receive video data and/or audio data, which can include one or more frames comprising digital images. In some embodiments, the pose monitoring platform 212 can acquire the digital image from image sensor 210 or one or more sensor units 222A-222N. In some embodiments, the pose monitoring platform 212 can receive digital images from external devices, including wireless cameras linked with a computing device (e.g., a GoPro® camera or webcam). The monitoring module 216 can receive such images in real time, during posing or operation of the camera by the computing device. By receiving such information, the pose monitoring platform 212 can acquire enough information to provide feedback to the user based on data relating to the user's body pose and/or environment based on monitoring the user's pose.

At step 404, the monitoring module 216 can provide the image to a first machine learning model, such as a machine learning model within the analysis module 218 and/or the body pose module 224. For example, the processing module 214 can provide the digital image to a first machine learning model as input as part of an inferencing operation, so as to obtain a first estimated pose of the user that is produced by the first machine learning model as output. The first machine learning model can include one or more model parameters that are received from a source external to the computing device, such as the server system 108, and associated with a generic machine learning model designed and trained to estimate pose. For example, the computing device 200 can include a machine learning model (e.g., a neural network 226 as utilized by body pose module 224) that is a local version of a generic machine learning model (e.g., has parameters derived from such a generic machine learning model). By utilizing a machine learning model trained on other users but is subsequently trained based on user data, the pose monitoring platform 212 enables further personalization of the model for improved accuracy, as disclosed herein.

In disclosed embodiments, the first machine learning model can be a lightweight model with a computational budget such that the model is able to operate, in real time, upon receipt of digital images. For example, the first machine learning model can be configured to execute inferencing operations or training operations during receipt of digital images of the environment in which the user is posed, and wherein a first number of model parameters associated with the first machine learning model is less than the second number of model parameters associated with a second machine learning model (e.g., a heavyweight model, as discussed above). Such a lightweight model can enable the pose monitoring platform 212 to provide real-time feedback to users of the computing device 200 by estimating poses upon receipt of digital images of the user while she is performing an activity. As such, the first machine learning model enables fast, personalized pose estimation, such that real-time pose monitoring can be performed.

At step 406, the analysis module 218 (e.g., through autolabeling module 230), can compute a confidence metric for the digital image and corresponding estimated pose. For example, the autolabeling module 230 can generate, for the first estimated pose, a first confidence metric that is indicative of a likelihood that the first estimated pose corresponds to an actual pose of the user, as described above. In some embodiments, the confidence metric can include a probability or a likelihood that the estimated pose corresponds to a user's ground-truth pose. For example, the autolabeling module 230 can calculate the confidence metric utilizing one or more machine learning models and/or the neural network 226. By generating a confidence metric, the pose monitoring platform 212 enables evaluation of the accuracy of a given estimated pose without manual or human labeling of the poses, thereby streamlining the model evaluation and training process.

In some embodiments, the autolabeling module 230 can provide the digital image and first estimated pose to a real-time confidence determination model for generation of the first confidence metric. For example, the autolabeling module 230 can provide the digital image and a representation of the first estimated pose to a real-time confidence determination model as input so as to obtain a probability that the first estimated pose corresponds to an actual pose of the user as output. The real-time confidence determination model can be configured to operate during generation of estimated poses by the first machine learning model. Additionally or alternatively, the real-time confidence determination model can be trained using actual pose data corresponding to actual poses of users. The autolabeling module 230 can generate the first confidence metric based on the probability that the first estimated pose corresponds to the actual pose of the user. By leveraging previous actual pose data to train the confidence determination model (which can include digital images of actual poses of users, as well as the resulting representation of the actual pose), the autolabeling module 230 enables in-situ evaluation of the accuracy of a given estimated pose, thereby improving evaluation of the pose estimation generated by the machine learning model without manual or human input. By doing so, the pose monitoring platform 212 enables efficient, automatic evaluation of models for subsequent training and/or tuning.

In disclosed embodiments, the autolabeling module 230 can generate the first confidence metric based on image transformations of the digital image and measuring the consistency of the resulting estimated pose subsequent to processing using the machine learning model. For example, the autolabeling module 230 can generate multiple image transformations of the digital image and provide these multiple image transformations of the digital image to the first machine learning model as part of an inference operation, so as to obtain multiple estimated poses of the user as output. The autolabeling module 230 can generate the first confidence metric based on variations among the multiple estimated poses.

For example, the multiple image transformations can correspond to at least one of: a positional shift, a flip, a color shift, and a rotation. By transforming the image as such and further evaluating the resulting estimated poses, the autolabeling module 230 can measure a degree of robustness or reliability of the module. In cases where the model evidently has low confidence in the estimated pose, such resulting estimated poses can differ more than for high confidence cases. For example, the autolabeling module 230 can generate an average deviation metric, wherein the average deviation metric indicates an average deviation of the resulting estimated poses from the calculated first estimated pose and, based on this average deviation, determine a confidence metric. Furthermore, the autolabeling module 230 can compare this average deviation metric with a threshold deviation metric to determine the confidence metric and/or a confidence indicator.

In some embodiments, the autolabeling module 230 can generate variations of the machine learning model and generate the confidence metric according to resulting estimated poses. For example, the autolabeling module 230 can generate multiple machine learning models based on variations of the one or more model parameters associated with the first machine learning model. The autolabeling module 230 can provide the digital image to each of the multiple machine learning models as part of inference operations, so as to obtain multiple estimated poses of the user as output. The autolabeling module 230 can generate the first confidence metric based on variations among the multiple estimated poses. For example, the autolabeling module 230 can generate an average deviation metric, wherein the average deviation metric indicates an average deviation of the multiple estimated poses from the calculated first estimated pose and, based on this average deviation, determine a confidence metric. Furthermore, the autolabeling module 230 can compare this average deviation metric with a threshold deviation metric to determine the confidence metric and/or a confidence indicator. By doing so, the autolabeling module 230 can provide an estimate of confidence in a given estimated pose based on an ensemble of models.

Note that confidence metrics can be calculated for other machine learning models using analogous ways to those discussed herein. The present disclosure should not be construed to limit the method of computation of confidence metrics to a single machine learning model or a subset of machine learning models.

At step 408, the autolabeling module 230 can compare the first confidence metric with a threshold value. For example, the autolabeling module 230 can compare the first confidence metric with a threshold value that is programmed in memory 204 of the computing device 200. The threshold value can be pre-programmed or determined based on characteristics of the user, environment and/or computing device, as discussed above. By doing so, the pose monitoring platform 212 enables determination of, for example, confidence indicators. Furthermore, doing so enables the autolabeling module 230 to determine estimated poses and corresponding digital images that are low confidence for further processing and correction, thereby improving the quality of estimated poses for possible training, tuning or improvements to the first machine learning model.

At step 410, the autolabeling module 230 can provide the image to a second machine learning model (e.g., a second machine learning model associated with the body pose module 224 and/or one or more neural networks 226), if the image is determined to have a low confidence estimated pose. For example, in response to a determination that the first confidence metric is less than the threshold value, the autolabeling module 230 can transmit or provide the digital image to a second machine learning model within the body pose module 224 as part of an inferencing operation, so as to obtain a second estimated pose of the user that is produced by the second machine learning model as output. For example, the autolabeling module 230 can provide these digital images to heavyweight machine learning model, which can provide improved estimated poses when compared to a lightweight machine learning model, as discussed above in relation to FIG. 2B. By doing so, the pose monitoring platform 212 enables improved re-evaluation of estimated poses that are determined to be likely inaccurate.

At step 412, the autolabeling module 230 can generate a second confidence metric based on the second estimated pose. For example, the autolabeling module 230 can generate, for the first estimated pose, a second confidence metric that is indicative of a likelihood that the second estimated pose corresponds to the actual pose of the user. As an illustrative example, the body pose module 230 can provide the output of the second machine learning model (e.g., the second estimated pose) to the autolabeling module 230 for generation of the second confidence metric. By doing so, the pose monitoring platform 212 enables evaluation of the second (e.g., heavyweight) machine learning model of body pose module 224, as well as for further generation of training data for the first machine learning model (e.g., the lightweight model).

At step 414, the autolabeling module 230 can determine whether the second confidence metric is indicative of a high confidence estimated pose and can generate training data accordingly. For example, in response to a determination that the second confidence metric is greater than the threshold value, the autolabeling module 230 can populate the digital image and the training estimated pose into a data structure (e.g., training data structure 234) that is representative of a training dataset to be used to tune the first machine learning model. The training module 232 can, in disclosed embodiments, further train or tune the lightweight machine learning model based on estimated poses that are likely to be accurate, even if the original lightweight model could not generate these during the time of operation. By doing so, the pose monitoring platform 212 enables personalized lightweight models to be retrained using accurate training data derived from heavyweight models, without further processing or updating by an external source.

In disclosed embodiments, the training module 232 can provide the training data to the second machine learning model for further training of this machine learning model (e.g., the heavyweight model). For example, in response to the determination that the second confidence metric is greater than the threshold value, the training module 232 can provide the data structure (e.g., the training data structure 234) that is representative of the training dataset to the second machine learning model, so as to tune the second machine learning model. By doing so, the training module 232 enables the body pose module to reinforce high-confidence estimated pose calculations for the heavyweight model (as well as, alternatively or additionally, for the lightweight model).

In disclosed embodiments, the computing device 200 can receive information regarding whether an estimated pose corresponds to an actual pose from an external source. For example, in response to a determination that the second confidence metric is less than the threshold value, the computing device 200 can generate, for display on an interface associated with the computing device (e.g., on the display mechanism 206), a request to transmit the digital image and the second estimated pose to a destination external to the computing device for generating a confidence indicator, wherein the confidence indicator indicates whether the second estimated pose corresponds to the actual pose of the user. In response to a response received form the user indicating permission to transmit the digital image, the pose monitoring platform 212 can transmit the digital image to the destination. The pose monitoring platform 212 can receive, from the destination, the confidence indicator for tuning the first machine learning model. The pose monitoring platform 212 can, as such, rely on information from sources external to the computing device 200 for confirmation and/or evaluation of estimated poses and their corresponding confidence indicators and/or confidence metrics.

FIG. 4B depicts a flow diagram 440 of a process for training local pose estimation models based on personalized training data using one or more components or modules described herein.

At step 442, the pose monitoring platform 212 (e.g., through the communication module 208), can receive a pose dataset including digital images and estimated poses. For example, each of the estimated poses of the pose dataset is associated with a corresponding one of the digital images. Each of the estimated poses may be output by one of multiple machine learning models upon being applied to the corresponding one of the digital images. For example, the pose monitoring platform 212 can receive a dataset that includes estimated poses corresponding to confidence metrics higher than the threshold value, as well as the corresponding digital images, such as those generated from the heavyweight machine learning model of the body pose module 224. In some embodiments, this pose dataset can be obtained from the training data structure 234, as produced by the training module 232. In some embodiments, this pose dataset corresponds to output from a machine learning model that has not be sorted into training data (e.g., sorted by confidence). As such, such high confidence estimated poses can be utilized to further process the estimated pose data and/or train, for example, the lightweight model.

At step 444, for each estimated pose of the pose dataset, the autolabeling module 230 can generate a corresponding confidence metric. For example, the autolabeling module 230 can generate a corresponding confidence metric that is indicative of a likelihood that the estimated pose corresponds to an actual pose of a human in the corresponding one of the digital images, as described above in relation to step 412. As such, the pose monitoring platform 212 enables evaluation of the output of pose estimation models and, as such, the generation of further training data.

In disclosed embodiments, the autolabeling module 230 can generate the corresponding confidence metrics using a real-time confidence determination model. For example, the autolabeling module 230 can provide the corresponding one of the digital images and a corresponding estimated pose to a real-time confidence determination model (e.g., a neural network 226) as input so as to obtain a corresponding probability that the corresponding estimated pose corresponds to an actual pose of a user as output, wherein the real-time confidence determination model is configured to operate during generation of estimated poses by the first machine learning model, and wherein the real-time confidence determination model is trained using actual pose data corresponding to actual poses of users. The autolabeling module 230 can generate the corresponding confidence metric based on the corresponding probability. As discussed previously, by utilizing a confidence determination model in real time, the pose monitoring platform 212 enables accurate determination of a likelihood of whether an estimated pose corresponds to an actual pose, thereby enabling accurate subsequent evaluation and training of machine learning models.

At step 446, the autolabeling module 230 can compare each confidence metric with a threshold value to identify a subset of the estimated poses. For example, the autolabeling module 230 can compare each confidence metric with a threshold value, so as to identify a subset of the estimated poses that have confidence metrics greater than the threshold value. By doing so, the autolabeling module 230 generates training data, comprising digital images and corresponding estimated poses, where estimated poses are likely accurate. By doing so, the autolabeling module 230 enables training data that can improve or correct, for example, the lightweight machine learning model, in situations or user environments where the lightweight machine learning model may have failed to generate accurate estimated poses.

At step 448 and step 450, the autolabeling module 230 can generate and provide the training module 232 with a training dataset accordingly. For example, the autolabeling module 230 can generate a training dataset that includes the subset of the estimated poses and a corresponding subset of the digital images. The autolabeling module 230 can provide the training dataset to a first machine learning model of the multiple machine learning models as input as part of a training operation, such that one or more model parameters corresponding to the first machine learning model are updated based on learnings from analysis of the training dataset. For example, the training module 232 can update a model (e.g., a lightweight model) using estimated poses deemed accurate based on the analysis disclosed above. As such, the training module 232 enables improvements to machine learning models based on processing low confidence images with, for example, a heavyweight model, even if such a heavyweight model cannot operate in real time.

In disclosed embodiments, the first machine learning model of the multiple machine learning models can be configured to operate in real time during image acquisition (e.g., as a lightweight model). For example, the first machine learning model is configured to operate during receipt of digital images of an environment in which a user of the computing device is posed. As such, the first machine learning model can be trained using personalized data based on low-confidence estimated poses generated by the lightweight model, which were then improved and updated by, for example, a heavyweight model.

In disclosed embodiments, the training operation can be executed on the computing device 200 as a background process. For example, the training module 232 can execute the training operation subsequent to obtaining estimated poses for a user of the computing device (e.g., as a background process where the corresponding application or software is otherwise inactive). By doing so, the pose monitoring platform 212 enables improvements to the pose monitoring machine learning models during subsequent use by the user.

At step 452, the pose monitoring platform 212, such as through the communication module 208, can transmit updated model parameters to an external destination for tuning machine learning models. For example, the training module 232 can transmit the one or more updated model parameters to a destination external to the computing device (e.g., the server system 108) for tuning a second machine learning model. For example, a generic machine learning model residing on the server system 108 can be updated based on the updated model parameters corresponding to the local version of the machine learning model. By doing so, the generic model can be updated for improved accuracy and robustness without transmission of sensitive data, including personal health information. In some embodiments, the second machine learning model can be trained based on training datasets from multiple computing devices corresponding to multiple users, as discussed in relation to FIG. 4C below.

In disclosed embodiments, the computing device 200 can receive and append training data from external sources to the training dataset. For example, the pose monitoring platform 212 can receive an external training dataset from a source external to the computing device. The external training dataset can include digital images, corresponding estimated poses, and corresponding confidence indicators, corresponding to users that indicated permission to transmit corresponding digital images to the location. The corresponding confidence indicators may indicate whether corresponding estimated poses are associated with actual poses of users. The pose monitoring platform 212 (e.g., through training module 232) can append the external training dataset to the training dataset for tuning the second machine learning model. For example, the pose monitoring platform 212 can incorporate training data trained by external sources (e.g., through manual, human labelers), thereby improving the quality of training data for subsequent updating of, for example, a generic machine learning model resident on the server system 108.

In disclosed embodiments, the pose monitoring platform 212 can revert model parameters associated with one or more machine learning models to previous model parameters upon determining a decrease in model performance. For example, the training module 232 can store first model parameters associated with the first machine learning model, wherein the first model parameters correspond to the one or more model parameters associated with the first machine learning model prior to updating the one or more model parameters based on the learnings from the analysis of the training dataset. The training module 232 can generate a first model performance metric corresponding to the first machine learning model, wherein the first model performance metric indicates a first average confidence metric for estimated poses output by the first machine learning model when using the first model parameters. The training module 232 can generate a second model performance metric corresponding to the first machine learning model, wherein the second model performance metric indicates a second average confidence metric for estimated poses output by the first machine learning model when using the one or more updated model parameters. The training module 232 can compare the first model performance metric and the second model performance metric. Based on determining that the second model performance metric is lower than the first model performance metric, the training module 232 can update the first machine learning model with the first model parameters. For example, average confidence metrics can be calculated as described in relation to FIG. 2B. By doing so, the training module 232 can ensure that models, e.g., as associated with the body pose module 224, do not decrease in accuracy; in the case of such a degradation in model performance, the pose monitoring platform 212 can thus revert to a prior state (with more desirable model parameters), thereby mitigating degradation in model quality over time.

FIG. 4C depicts a flow diagram 480 of a process for updating a generic machine learning model based on training a local or personalized pose estimation model using one or more components or modules disclosed herein.

At step 482, the server system 108 can receive multiple sets of model parameters from multiple computing devices. For example, each of the multiple sets of model parameters can include model parameters of a corresponding local version of the machine learning model that is tuned by a corresponding computing device of the multiple computing devices to account for one or more characteristics that are specific to a user or an environment of the corresponding computing device. For example, the server system 108 can receive model parameters of models (e.g., heavy- or lightweight models on computing devices) that have been personalized, tuned and/or updated based on individual users' environments.

In disclosed embodiments, the local versions of the machine learning models are associated with corresponding users and are personalized. For example, for each of the multiple sets of model parameters, the corresponding local version of the machine learning model is associated with a corresponding user device (e.g., a computing device 200) and trained on estimated poses and corresponding digital images. By doing so, the system can receive information that can enable personalization and/or improved accuracy of a generic model, without the requirement of any transmission of personal health information or other identifiable information. In disclosed embodiments, these estimated poses can have associated confidence metrics greater than a threshold value. For example, the associated confidence metrics can be indicative of likelihoods that estimated poses correspond to actual poses of users. Thus, in this example, the server system 108 receives only model parameters that correspond to models that yield high confidence metrics (e.g., that are more accurate), thereby improving the quality of training data received by the server system 108.

At step 484, the server system 108 can generate a set of average model parameters based on the multiple sets of model parameters. For example, each average model parameter can be representative of an average of a corresponding model parameters across the multiple sets of model parameters. At step 486, the server system 108 can update the machine learning model to include the set of average model parameters. As discussed above in relation to FIG. 2B, the average model parameters can be used to incorporate the personalized updated model parameters into a generic machine learning model that resides on the server system 108, thereby improving the accuracy and robustness of the generic machine learning model.

At step 488, in response to receiving, from a given computing device, input that is indicative of a request for model parameters associated with the machine learning model, the server system 108 can transmit the set of average model parameters to the given computing device for generation of a local version of the machine learning model. By doing so, the personalized or local machine learning models housed on corresponding computing devices (e.g., the computing device 200) can leverage the machine learning model that is trained on more users and computing devices (e.g., the generic machine learning model housed on the server system 108), thereby improving the personalized models' accuracy and reliability.

In disclosed embodiments, the server system 108 can transmit a subset of model parameters to a local version of the machine learning model, based on whether the model parameters are associated with high enough confidence metrics (e.g., as compared to a threshold). For example, the system can determine multiple average confidence metrics corresponding to the multiple sets of model parameters, wherein each average confidence metric in the multiple average confidence metrics indicates, for each set of model parameters in the multiple sets of model parameters, a corresponding average confidence metric. The corresponding average confidence metric can include an average of multiple confidence metrics that are indicative of likelihoods that estimated poses correspond to actual poses of users. As described above in relation to FIG. 2B, by doing so, the server system 108 can improve the quality of updates provided to local versions of machine learning models by selecting model parameters to update that are likely associated with more accurate training data (e.g., more accurate estimated poses).

In disclosed embodiments, the local version of the machine learning model may correspond to a lightweight model. For example, the local version of the machine learning model can be configured to execute inference operations or training operations on the given computing device during receipt of digital images of an environment in which a user is posed. As such, the server system 108 can transmit the set of average model parameters to the computing device 200 for updating a local, “lightweight” model, which can be executed for inference and/or training during receipt and/or processing of digital images. By doing so, the server system 108 enables training and improvements to the local version of the machine learning model based on larger datasets received at the server system 108, even if the local version cannot execute such training in real time otherwise (e.g., due to constraints on the number of model weights and/or parameters within the model that prevent efficient real-time operation or sufficient accuracy).

In disclosed embodiments, the local version of the machine learning model may correspond to a heavyweight model. For example, the local version of the machine learning model can be configured to execute inference operations or training operations on the given computing device as a background process, subsequent to obtaining estimated poses for a user of the given computing device. As such, the server system 108 can transmit the set of average model parameters to the computing device 200 for updating a local, “heavyweight” model, which can be executed for inference and/or training in the background, such as when substantial use of computational resources is not occurring. By doing so, the server system 108 enables training and improvements to an accurate version of the personalized machine learning model, thereby enabling improved subsequent training data generation and model tuning.

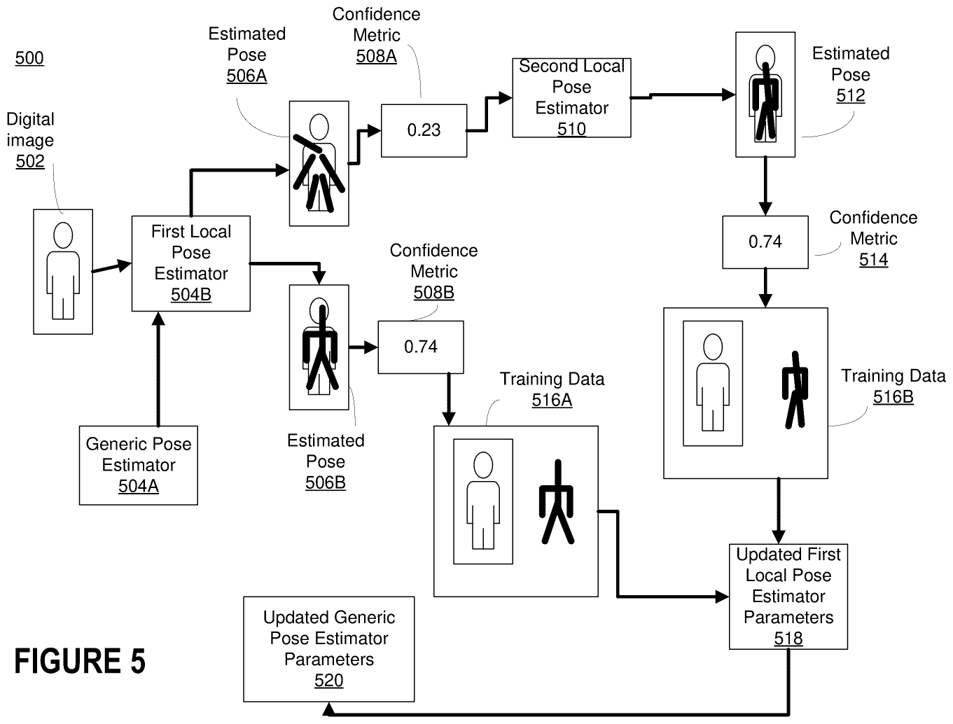

FIG. 5 depicts a flow diagram 500 of a process leveraging confidence metrics to generate training data from pose estimation models, using one or more components or modules described herein. For example, a user can use computing device 200 (e.g., corresponding image sensor 210) to capture the digital image 502 and submit this to a first local pose estimator 504B. For example, the local pose estimator can include a machine learning model, and can be derived from a generic pose estimator 504A (e.g., a generic machine learning model). The first local pose estimator 504B can generate an estimated pose 506A with a confidence metric 508A below a threshold value (e.g., because the estimated pose 506A is determined not to likely correspond to an actual pose). In response to this low confidence metric 508A, the autolabeling module 230 can transmit this digital image to a second local pose estimator 510 (e.g., a second, heavyweight machine learning model). The second local pose estimator 510 can generate a second estimate pose 512, with a confidence metric 514 which may be above the threshold value.

Having determined that the confidence metric 514 is above the threshold value, the autolabeling module 230 can generate the digital image 502 and the estimated pose 512 within a training data structure, such as training data 516B for further training of the first local pose estimator. The trained first local pose estimator 504B (with updated first local pose estimator parameters 518) can subsequently be used to update the parameters for generic pose estimator 504A (e.g., updated generic pose estimator parameters 520) for further improvements to the first local pose estimator 504B on the present computing device and/or on other computing devices.

In cases where the first local pose estimator 504B generates an estimated pose 506B with a confidence metric 508B above the threshold value, the autolabeling module 230 can generate training data 516A based on the digital image 502 and the estimated pose 506B, and update the first local pose estimator 504B accordingly (e.g., to generate the updated first local pose estimator parameters 518).

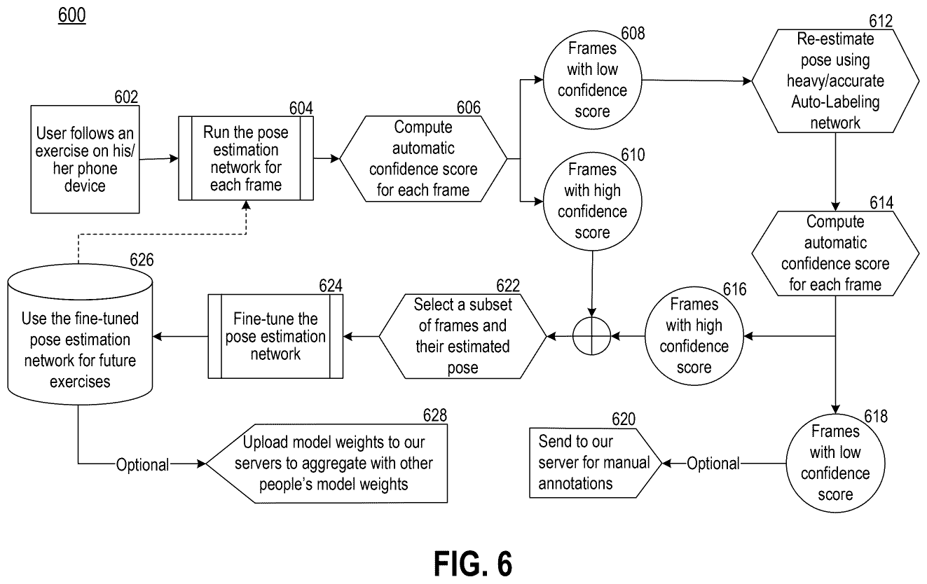

FIG. 6 depicts a flow diagram 600 of a process for evaluating frames to generate confidence metrics for training of local and generalized pose estimation models, using one or more components or modules disclosed herein.

For example, at step 602, a user can follow an exercise on his/her/their phone device (e.g., a computing device 200). At step 604, the body pose module 224 can run the pose estimation network (e.g., a machine learning model and/or the neural network 226) for each frame (e.g., digital image) received from the phone device. At step 606, the autolabeling module 230 can compute an automatic confidence score (e.g., confidence metric) for each frame. Frames with low confidence scores (e.g., below a threshold value), at step 608, can be separated from frames with high confidence scores, at step 610.

At step 612, frames with low confidence scores can be run through a more accurate auto-labeling network (e.g., a heavyweight model) for further re-estimation of the pose. At step 614, the autolabeling module can compute an automatic confidence score for each frame. At step 616, the frames with the higher confidence score can be separated from frames with a low confidence score, at step 618 (e.g., as compared with the threshold value). Frames with a low confidence score can be sent to the server system 108 for manual labeling or annotations, at step 620.

At step 622, frames with high confidence scores can be selected, and the pose estimation network can be fine-tuned based on a subset of these frames (and corresponding estimated poses) at step 624. At step 626, the updated pose estimation network can be used for further analysis of user exercises. In some embodiments, the corresponding model weights can be uploaded to the server system 108 to aggregate with other people's model weights at step 628.

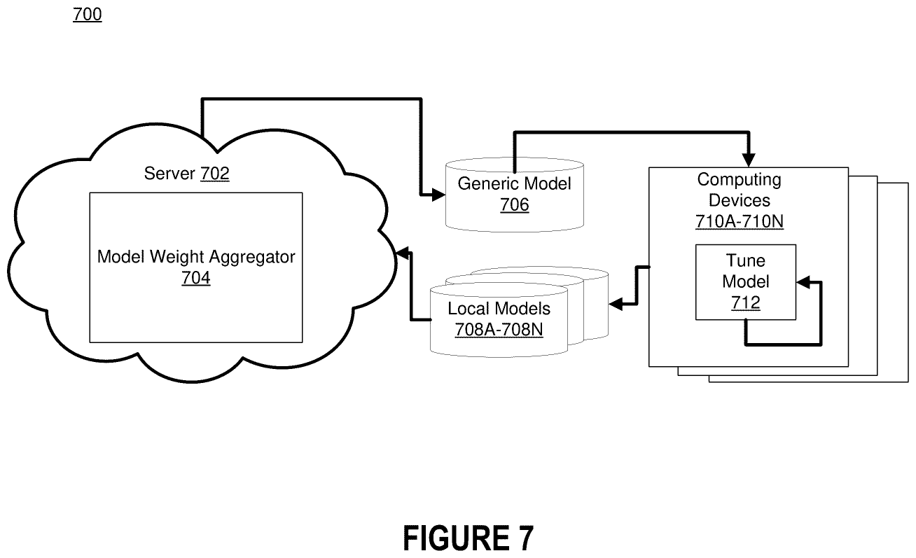

FIG. 7 depicts a flowchart 700 depicting model weight aggregation of model parameters associated with a tuned model on computing devices associated with different users, using one or more components or modules described herein.

For example, at the server 702 (e.g., the server system 108), the model weight aggregator 704 can generate or store model weights acquired from multiple local models 708A-708N. The model weight aggregator 704 can update a generic model 706 (e.g., a generic machine learning model) based on these model weights, which can then be used to generate models on computing devices 710A-710N (e.g., each of which may represent an instance of computing device 200). Based on the processes described herein, models within the computing devices 710A-710N can be tuned at step 712 in order to generate and/or update local models 708A-708N. The local models 708A-708N can be used to further update model weights stored at the server 702 (e.g., by further aggregating these model weights at model weight aggregator 704).

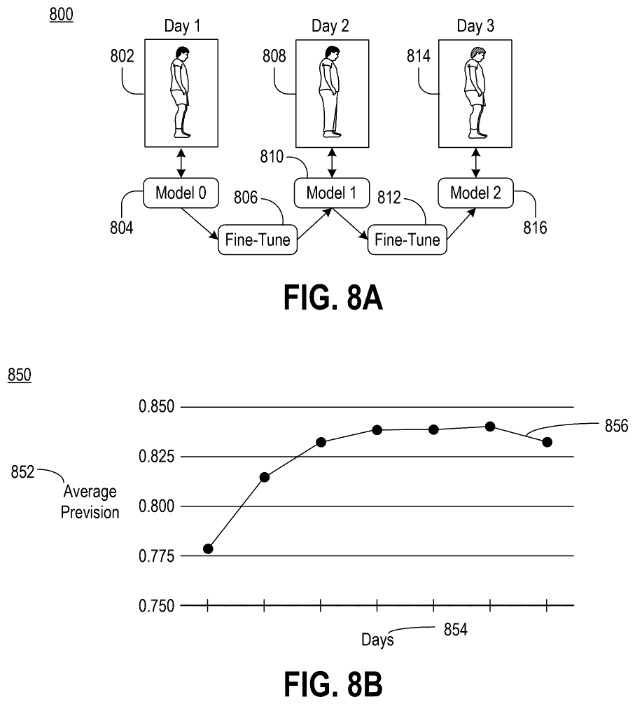

FIG. 8A depicts a schematic 800 representing tuning of a local pose estimation model based on digital images corresponding to a user. For example, on Day 1, a user may transmit, to the pose monitoring platform 212, a first digital image 802 and pass this through a local machine learning model 804. Based on the processes and methods described herein, the autolabeling module 230 and the training module 232 can tune this model at step 806 to generate a second version of the local model 810. Thus, on Day 2, the user can transmit a second digital image 808 to the pose monitoring platform 212 and continue to tune the model at step 812 to generate a third version of model 816. This third version of the model 816 can be used to process a third digital image 814 from Day 3.

Those skilled in the art will recognize that the first, second, and third digital images 802, 808, 814 need not necessarily be generated on consecutive days, nor do the second and third versions 810, 8016 of the local model 804 necessarily be generated on consecutive days. There may be some delay. For example, the local model 804 could be used in its original form for several days, weeks, or months—or until performance is determined to fall below a threshold—before the second version 810 of the local model 804 is generated. Similarly, the second version 810 of the local model 804 could be used for several days, weeks, or months—or until performance is determined to fall below the threshold—before the third version 816 of the local model 804 is generated. In some embodiments, the delays between deployment and “retuning” or “retraining” correspond to fixed intervals of time (e.g., 3 days, 7 days, 14 days, 30 days). In other embodiments, the delays between deployment and “retuning” or “retraining” are dynamically determined based on a continual or periodic analysis of performance. In other embodiments, the delays between deployment and “retuning” or “retraining” correspond to progress through a program. For example, the local model 804 could be tuned whenever the user completed 5 sessions, 10 sessions, or 20 sessions, or whenever the user requests that retuning occur (e.g., in response to determining that the pose monitoring platform is not able to accurately monitor performances of activities with sufficient consistency).

FIG. 8B depicts improvements in accuracy for a user's estimated pose over time based on training of a personalized pose estimation model. Over the execution of the process described in relation to FIG. 8A, the pose monitoring platform 212 enables more and more accurate results of pose estimation. For example, a plot 850 demonstrates how average precision 852 varies over multiple days 854, where average precision represents a measure of the average precision of various keypoint positions of interest. The number and arrangement of keypoint positions (e.g., in 2D or 3D space) may vary depending on the nature of the activity that the user is tasked with performing and which is subsequently visually monitored. As depicted on the plot 850, the fine-tuning procedure of pose estimation models described herein enables improvements to the average precision of pose estimation over time, represented by timeseries 856.

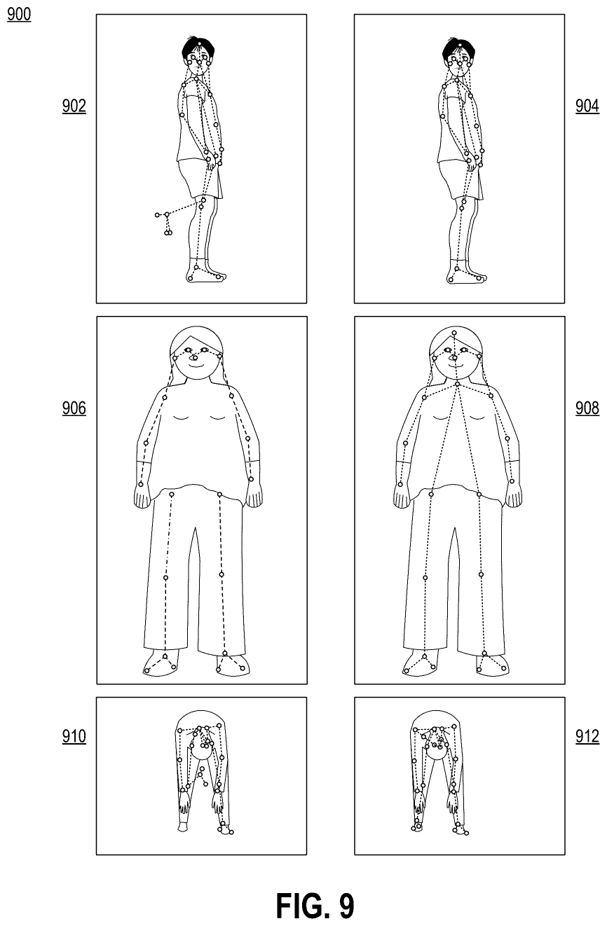

FIG. 9 depicts a schematic 900 to demonstrate errors in pose estimation mitigated by improved training of personalized pose estimation models. For example, the image 902 depicts an actual pose by a human (e.g., user) that is not represented well by the corresponding estimated pose (indicated by the lines and dots), due to the couch in the background. Based on tuning this local machine learning model, as described herein, the machine learning model is able to represent the estimated pose accurately within the digital image 904.

Similarly, the image 906 depicts an actual pose where, due to shadows on the users' sweater, the corresponding estimated pose is missing segments. By fine-tuning the model using the methods and systems described herein, the local version of the machine learning model is able to capture the actual pose of the user more accurately, as shown through the updated estimated pose in image 908.

The image 910 depicts an actual pose where, due to objects on the couch in the background, the estimated pose of the user's right leg is not correct. By fine-tuning the model using the methods and systems described herein, the local version of the machine learning model is able to capture the user's pose more accurately, as shown in image 912.

### Processing System

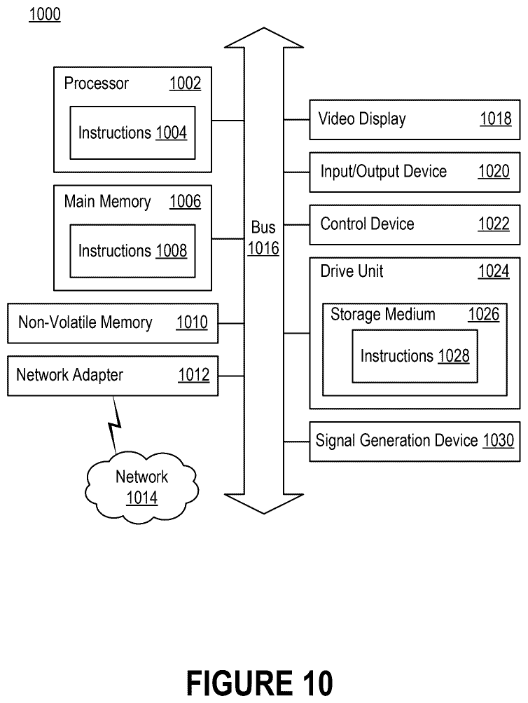

FIG. 10 is a block diagram illustrating an example of a processing system 1000 in which at least some operations described herein can be implemented. For example, components of the processing system 1000 may be hosted on a computing device that includes a pose monitoring platform (e.g., pose monitoring platform 102 of FIG. 1, pose monitoring platform 212 of FIG. 2B, or pose monitoring platforms 302, 352 of FIGS. 3A-B).

The processing system 1000 may include a processor 1002, main memory 1006, non-volatile memory 1010, network adapter 1012, video display 1018, input/output device 1020, control device 1022 (e.g., a keyboard or pointing device), drive unit 1024 including a storage medium 1026 (e.g., a non-transitory storage medium), and signal generation device 1030 that are communicatively connected to a bus 1016. The bus 1016 is illustrated as an abstraction that represents one or more physical buses or point-to-point connections that are connected by appropriate bridges, adapters, or controllers. The bus 1016, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I2C) bus, or an Institute of Electrical and Electronics Engineers (IEEE) standard 1394 bus (also referred to as “Firewire”).

While the main memory 1006, non-volatile memory 1010, and storage medium 1026 are shown to be a single medium, the terms “machine-readable medium” and “storage medium” should be taken to include a single medium or multiple media (e.g., a centralized/distributed database and/or associated caches and servers) that store one or more sets of instructions 1028. The terms “machine-readable medium” and “storage medium” shall also be taken to include any medium that is capable of storing, encoding, or carrying a set of instructions for execution by the processing system 1000.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in a computing device. When read and executed by the processors 1002, the instruction(s) cause the processing system 1000 to perform operations to execute elements involving the various aspects of the present disclosure.

Further examples of machine- and computer-readable media include recordable-type media, such as volatile memory devices and non-volatile memory devices 1010, removable disks, hard disk drives, and optical disks (e.g., Compact Disk Read-Only Memory (CD-ROMS) and Digital Versatile Disks (DVDs)), and transmission-type media, such as digital and analog communication links.

The network adapter 1012 enables the processing system 1000 to mediate data in a network 1014 with an entity that is external to the processing system 1000 through any communication protocol supported by the processing system 1000 and the external entity. The network adapter 1012 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method performed by a computer program executed on a computing device, the method comprising:
receiving, from a camera included in the computing device, a digital image of an environment in which a user is posed;
providing the digital image to a first machine learning model as input as part of an inferencing operation, so as to obtain a first estimated pose of the user that is produced by the first machine learning model as output,
wherein the first machine learning model comprises one or more model parameters that are received from a source external to the computing device and associated with a generic machine learning model designed and trained to estimate pose;
generating, for the first estimated pose, a first confidence metric that is indicative of a likelihood that the first estimated pose corresponds to an actual pose of the user;
comparing the first confidence metric with a threshold value that is programmed in memory of the computing device;
in response to a determination that the first confidence metric is less than the threshold value,
providing the digital image to a second machine learning model as input as part of an inferencing operation, so as to obtain a second estimated pose of the user that is produced by the second machine learning model as output;
generating, for the first estimated pose, a second confidence metric that is indicative of a likelihood that the second estimated pose corresponds to the actual pose of the user; and
in response to a determination that the second confidence metric is greater than the threshold value,
populating the digital image and the second estimated pose into a data structure that is representative of a training dataset to be used to tune the first machine learning model.

2. The method of claim 1, wherein the first machine learning model is configured to execute inferencing operations or training operations during receipt of digital images of the environment in which the user is posed, and wherein a first number of model parameters associated with the first machine learning model is less than a second number of model parameters associated with the second machine learning model.

3. The method of claim 1, wherein generating, for the first estimated pose, the first confidence metric comprises:
providing the digital image and a representation of the first estimated pose to a real-time confidence determination model as input so as to obtain a probability that the first estimated pose corresponds to an actual pose of the user as output,
wherein the real-time confidence determination model is configured to operate during generation of estimated poses by the first machine learning model, and
wherein the real-time confidence determination model is trained using actual pose data corresponding to actual poses of users; and
generating the first confidence metric based on the probability that the first estimated pose corresponds to the actual pose of the user.

4. The method of claim 1, wherein generating, for the first estimated pose, the first confidence metric comprises:
generating multiple image transformations of the digital image;
providing the multiple image transformations of the digital image to the first machine learning model as part of an inference operation, so as to obtain multiple estimated poses of the user as output; and
generating the first confidence metric based on variations among the multiple estimated poses.

5. The method of claim 4, wherein the multiple image transformations correspond to at least one of: (1) a positional shift, (2) a flip, (3) a color shift, and (4) a rotation.

6. The method of claim 1, wherein generating, for the first estimated pose, the first confidence metric comprises:
generating multiple machine learning models based on variations of the one or more model parameters associated with the first machine learning model;
providing the digital image to each of the multiple machine learning models as part of inference operations, so as to obtain multiple estimated poses of the user as output; and
generating the first confidence metric based on variations among the multiple estimated poses.

7. The method of claim 1, further comprising:
in response to the determination that the second confidence metric is greater than the threshold value,
providing the data structure that is representative of the training dataset to the second machine learning model, so as to tune the second machine learning model.

8. The method of claim 1, further comprising:
in response to a determination that the second confidence metric is less than the threshold value,
generating, for display on an interface associated with the computing device, a request to transmit the digital image and the second estimated pose to a destination external to the computing device for generating a confidence indicator,
wherein the confidence indicator indicates whether the second estimated pose corresponds to the actual pose of the user;
in response to a response received from the user indicating permission to transmit the digital image, transmitting the digital image to the destination; and
receiving, from the destination, the confidence indicator for tuning the first machine learning model.

9. A computing device including:
(i) one or more processors; and
(ii) a non-transitory, computer-readable storage medium storing instructions that, when executed by the one or more processors of the computing device, cause the computing device to perform operations comprising:
receiving a pose dataset that includes digital images and estimated poses,
wherein each of the estimated poses is associated with a corresponding one of the digital images, and
wherein each of the estimated poses is output by either (i) a first machine learning model designed for pose estimation or (ii) a second machine learning model designed for pose estimation that, in operation, consumes more computational resources than the first machine learning model;
for each estimated pose,
generating a corresponding confidence metric that is indicative of a likelihood that the estimated pose corresponds to an actual pose of a human in the corresponding one of the digital images;
comparing each confidence metric with a threshold value, so as to identify a subset of the estimated poses that have confidence metrics greater than the threshold value;
generating a training dataset that includes the subset of the estimated poses and a corresponding subset of the digital images;
providing the training dataset to the second machine learning model as input as part of a training operation, such that one or more model parameters corresponding to the first machine learning model are updated based on learnings from analysis of the training dataset; and
transmitting the one or more updated model parameters to a destination external to the computing device for tuning a third machine learning model.

10. The computing device of claim 9, wherein the third machine learning model is trained based on training datasets from multiple computing devices corresponding to multiple users.

11. The computing device of claim 9, wherein the first machine learning model is configured to operate during receipt of digital images of an environment in which a user of the computing device is posed.

12. The computing device of claim 9, wherein the instructions cause the computing device to perform operations comprising:
receiving an external training dataset from a source external to the computing device,
wherein the external training dataset includes digital images, corresponding estimated poses and corresponding confidence indicators corresponding to users that indicated permission to transmit corresponding digital images to the source,
wherein the corresponding confidence indicators indicate whether corresponding estimated poses are associated with actual poses of users; and
appending the external training dataset to the training dataset for tuning the third machine learning model.

13. The computing device of claim 9, wherein the training operation is executed on the computing device as a background process, subsequent to obtaining estimated poses for a user of the computing device.

14. The computing device of claim 9, wherein the instructions cause operations comprising:
providing the corresponding one of the digital images and a corresponding estimated pose to a real-time confidence determination model as input so as to obtain a corresponding probability that the corresponding estimated pose corresponds to an actual pose of a user as output,
wherein the real-time confidence determination model is configured to operate during generation of estimated poses by the first machine learning model, and
wherein the real-time confidence determination model is trained using actual pose data corresponding to actual poses of users; and
generating the corresponding confidence metric based on the corresponding probability.

15. The computing device of claim 9, wherein the instructions cause operations comprising:
storing first model parameters associated with the second machine learning model, wherein the first model parameters correspond to the one or more model parameters associated with the second machine learning model prior to updating the one or more model parameters based on the learnings from the analysis of the training dataset;
generating a first model performance metric corresponding to the second machine learning model, wherein the first model performance metric indicates a first average confidence metric for estimated poses output by the second machine learning model when using the first model parameters;
generating a second model performance metric corresponding to the second machine learning model, wherein the second model performance metric indicates a second average confidence metric for estimated poses output by the second machine learning model when using the one or more updated model parameters;
comparing the first model performance metric and the second model performance metric; and
based on determining that the second model performance metric is lower than the first model performance metric, updating the second machine learning model with the first model parameters.

16. A non-transitory, computer-readable medium storing:
(i) a machine learning model that is developed and trained to estimate pose, and
(ii) instructions that, when executed by one or more processors, cause the one or more processors to perform operations comprising:
receiving multiple sets of model parameters from multiple computing devices,
wherein each of the multiple sets of model parameters includes model parameters of a corresponding local version of the machine learning model that is tuned by a corresponding computing device of the multiple computing devices to account for one or more characteristics that are specific to a user or an environment of the corresponding computing device;
generating a set of average model parameters based on the multiple sets of model parameters,
wherein each average model parameter is representative of an average of a corresponding model parameter across the multiple sets of model parameters;
updating the machine learning model to include the set of average model parameters; and
in response to receiving, from a given computing device, input that is indicative of a request for model parameters associated with the machine learning model,
transmitting the set of average model parameters to the given computing device for generation of a local version of the machine learning model.

17. The non-transitory, computer-readable medium of claim 16, wherein, for each of the multiple sets of model parameters, the corresponding local version of the machine learning model is associated with a corresponding user device and trained on estimated poses and corresponding digital images.

18. The non-transitory, computer-readable medium of claim 17,
wherein the estimated poses have associated confidence metrics greater than a threshold value, and
wherein the associated confidence metrics are indicative of likelihoods that estimated poses correspond to actual poses of users.

19. The non-transitory, computer-readable medium of claim 16, wherein the instructions further cause the one or more processors to perform operations comprising:
determining multiple average confidence metrics corresponding to the multiple sets of model parameters,
wherein each average confidence metric in the multiple average confidence metrics indicates, for each set of model parameters in the multiple sets of model parameters, a corresponding average confidence metric,
wherein the corresponding average confidence metric includes an average of multiple confidence metrics that are indicative of likelihoods that estimated poses correspond to actual poses of users;
based on comparing each average confidence metric in the multiple average confidence metrics with a threshold metric, determining a subset of the multiple average confidence metrics and a corresponding subset of model parameters; and
transmitting the corresponding subset of model parameters to the given computing device for generation of the local version of the machine learning model.

20. The non-transitory, computer-readable medium of claim 16, wherein the local version of the machine learning model is configured to execute inference operations or training operations on the given computing device during receipt of digital images of an environment in which a user is posed.

21. The non-transitory, computer-readable medium of claim 16, wherein the local version of the machine learning model is configured to execute inference operations or training operations on the given computing device as a background process, subsequent to obtaining estimated poses for a user of the given computing device.
